(19) United States
(12) Patent Application Publication
(10) Pub. No.: US 2004/0255137 A1
(43) Pub. Date: Dec. 16, 2004

(54) Defending the name space

(76) Inventor: Shuqian Ying, Vancouver (CA)

Correspondence Address: Shuqian Ying, 810 E 12th Ave, Vancouver, BC, V5T 2J2, CA

(21) Appl. No.: 10/752,695

(22) Filed: Jan. 8, 2004

Related U.S. Application Data
(60) Provisional application No. 60/438,796, filed on Jan. 9, 2003.

(51) Int. Cl. H04L 9/00

(52) U.S. Cl. 713/193

(57) ABSTRACT

This invention is about an global entity oriented declarative authentication and security system that can be used in the present and future internet based distributed applications and services. An entity here refers to an unique object (most likely to be physical or human) or aspect that can hardly be duplicated. The system provides both authentication and security (A & S). It can be used in areas comprising one to one or one to many (OR or AND) content publication or distribution so that maximum granularity of access control is made possible. Examples comprise 1) A & S in messaging or communication (one to one). 2) A & S in publication or distribution or information sharing (one to many(OR)). 3) Secured document escrowing (one to many(AND)). 4) Declarative just in time A & S for web-services. 5) Copyright protection for digital products. 6) Digital cash. 7) Internet based electronic voting system. 8) Witnessed digital legal papers. 9) Support large scale virtualized virtual private network and its applications. 10) etc.

### REALIZATION EXECUTABLES

Particular realizations of the technology of this patent are continuously evolved. They can be obtained from http://www.cryptogateway.com. At times of your reading, three series of products are likely available:

1. COMPOSER series. Used mainly by users of digital content, management and services.

2. DISTRIBUTOR series. Used mainly by security administrators, content producers or publishers.

3. The crypto-gateway server. A collection of core services that realizes the technology of this patent. Part of the personal version of it is hosted by the COMPOSER and DISTRIBUTOR series.

### NOTICE REGARDING COPYRIGHTED MATERIAL

Some portions of the disclosure of this patent are subject to copyright protection. The facsimile reproduction is granted to anyone as it appears in the Patent and Trademark Office file or records, but otherwise all copyright rights are reserved.

### BACKGROUND—FIELD OF INVENTION

The rapid expansion of internet in its scope and capabilities makes it possible for a single computer to be connected to a vast number of others. It is expected to lead to a qualitative change in the nature of computing and information sharing. The previous localized nature of the said process can now be spread all over the net, instantaneously and automatically. Such an increasing connectivity brings new problems that are either considered insignificant or not even relevant when the computers are left alone. Although the current status of the internet is still far from such a stage. It's early symptoms have manifested in various internet application domains, like the spam in e-mail message systems, the hard to be balanced rights management between the producer and consumer of digital products and between the technical advantages and the commercial and security disadvantages of the so called peer to peer network, etc. A list of causes at a deeper level that are concerned in this invention is presented in the following

1. Management of “links” or security. Internet is about connection using which information can be exchanged. Security almost always implies the reduction of information exchange before the bandwidth of physical network is increased. Sometimes even this is needed provided that it can be controlled in a positive way to achieve overall benefit since this is only one side of the equation. The amount of information exchange increases with the useful contents and services that are produced and published on the web and with the confidence that a customer to use these contents and services when their private information has certain means to be secured. Information exchange also increases when the internet helps to enhance and develop more effective human social network. The current invention is about increasing link security and also about increase the virtual bandwidth of virtual communication links given the same physical network using cryptographic means. In reveals and made possible to potentially utilize a new “dimension” of the internet along the direction of realizable bandwidth of any physical networks. To be more specific, the normal use of the network is to transmit bit sequences that represent highly correlated bit sequences conforming to the grammar of certain natural languages or pattern for Human and computers which are in fact an increasingly small subset of all possibles as the time (or the length of the bit sequence) is increased. On the other hand, the physical transport layer is not limited by that at all. Or, it can be viewed as a virtual global “positioning” system of identities (VGPSI). There are various aspects to the problem as a whole, I am going to try to focus on the following more practical aspects concerned in this invention

(a) Protection of privacy. General purpose data or computation centers and/or well connected clusters of peer to peer (virtual) network could emerge as a result of the increasing complexity and popularity of the internet. They enable users to store, share, manipulate, and/or transmit-personal or collective (corporate, institutional, etc.) information and universal knowledge, participate in collaborative works and many others not foreseeable at present. Depending on the nature of the information, there could be a need to control the group of individuals who can access it. For example, scientific knowledge (as oppose to information) should be shared to anyone, on the other hand, personal credit card information should be shared only with related bank involved in the transaction. The problem is thus narrowed down to develop a system flexible enough to realize such a control, in a non-centralized fashion, serve/driven by the user's needs, and consistent with the present and aid to make future laws (new laws may be required to reflect the new reality of the internet). Without it, the above mentioned non-local nature of the internet make it possible for overlapping or duplicating (virtual) network links to form to interfere with each other either intentionally or unintentional. For example, it is possible for technically privileged individuals and/or groups to harvest the vast amount of information for certain gains outside of the allowance of the law. Existing technologies are not adequate enough to address such an issue.

(b) Identification and Authentication. The internet make it possible for people from geologically separated locations to “meet” each other. The convenience it brings is obvious. But it leaves the problem of who an individual is really interacting with. Traditional human instinct of recognize known people by facial, vocal, body characteristics and many other subconscious means fail to play any role here due to the physical separation. The government and intermediate agencies are also less efficient in providing identity confirmation and proof on the internet compared to the traditional situations. Identity theft is a reality of today and could become worse in the future if nothing is done about it. The limitation of a computer in identity authentication on the internet originates in part from the said non-local nature and from the digitization of the human credentials. Digital information has finite bits and can be reproduced exactly whence it is intercepted, once and for all. To prevent a proliferation of digital replica of an individual or organization on the internet, strong authentication is needed. The principle is to trust whatever the declared identity of an individual, authentication are done when “it matters” nevertheless, which is called temporal localization, as oppose to do it once and trust it all along (temporal non-localization). Public key cryptography provides means to realize an effective spatial localization of authentication, a resemblance of the traditional ways that were well tested and trusted. This will be explained in the main text.

(c) Reliability of computer services. Web services and/or other distributed services, pushed by major players of the field, could be the next big thing during the evolution of the internet. While a client machine do not have such a problem as denial or abuse of the services, servers that provide them, could be “attacked” by malicious intruders, by badly designed client software from an irresponsible developer during development or by certain random fluctuations in a strongly coupled internet on which most of the users are not known to each other. One could place a front assess point (software) for the service which act both as an authenticator and as a barrier of the “attack” so that critical information of the server pertaining to other clients would be preserved even if one of the restartable front ends is crashed. Traditional firewalls which filter connections based on domain name, IP address and/or software name, all of which are of secondary importance because they do not represent a real user and can be spoofed, may not serve such a purpose well. One need new kind of finer grained gateway that can recognize incoming call base on entity (typically a human behind the call) if needed so that the exact origin of the call, which really matters, can be controlled and is traceable. This is regarded as the “right” of the service provider discussed in the following.

2. Management of “rights” of various parties involved in the connection. The proper interpretation of the concept of “right” that occurs on the internet should be given by the law and their balance adjusted during the interaction between said parties in a given social and economical context, a flexible technical solution that gives more control to the right holders (to who it really matters, this is called entity control localization) that can reflect and adapt to such a balance should be sought. Without such a technical mean, it can be difficult to achieve a balanced stable environment in this new arena due to the nature of the new capabilities of internet. A fit to all type of solution is certainly inadequate at the present and is also beyond the capability of any technical inventors or organizations.

(a) The rights of consumer. The part of the consumer right that this invention is about is mainly around the right to own their identity, to control their privacy and to enjoy a fair distribution of wealth to be brought about by the evolving internet. The possibility of identity theft and intrusion of privacy on the internet is mentioned above. These problems are a fact of life even at the present stage of the internet evolution.

(b) The rights of the producer. The part of the producer's right concerned here is about the copyright of digital products. The internet provides a potentially much larger audience base (or market) and a much easier and faster distribution channel for the digital products of the right holders. However digitization renders wide spread of unauthorized copying of such products, well beyond what is called “fair use” in the more conventional distribution channel of the said products. Such a situation could result in two extremes in short terms: overly powerful/wealthy producers and starving to death ones. The former could kill the consumer base and later could kill the producer one in not so long run before proper actions can be sort out. There need to be a technical solution to make it possible for multiple parties (consumers on the one side and producers on the other) to make compromises according the law and market conditions.

3. Management of the web of trusts. When trust relationships in real life and/or in trusted local area networks are going to be mirrored or dispersed on the distributed public internet, many issues arises (for social one, see e.g., Ref. [1]). A system that will help to establish a reliable mirroring, realize secured virtual localization, and develop them based on or on top of existing ones using modern tools is disclosed here and in invention [2].

It is found that many aspects of the problems described above can be traced back to the problems related to the possibility of the “name space” corruption or manipulation by natural processes or by unknown “middle men”, which is made possible by the non-local nature (in the spatial, temporal and entity right control sense) and also by the computing and information sharing processes on the internet (in fact many real life scams are also based on it).

Cryptographic techniques offers a possible solution.

### BACKGROUND—DESCRIPTION OF PRIOR ART

The goals of a modern cryptographic system are to provide the following capabilities (ref. [3], the interpretation is ours if difference occurs) to the information exchange, retrieving and distribution processes

1. Identification: The allocation of an unique “name space position” for each entity.

2. Authentication: The verification of whether or not a given entity has indeed the claimed name space value and the corresponding quality.

3. Authorization: The assignment of possible actions that a given named entity can perform in a given context.

4. Integrity: Traditionally this refers to the integrity of the messages been transmitted. Here it also refers to the integrity of any generalized hyper-link that references to them.

5. Confidentiality: The encryption of messages, the safeguard of private keys, etc.

6. Non-repudiation: Provided 1) and 2) are properly implemented, this is automatically satisfied. It is not the case at present as it is shown in the following.

7. Impersonation: The act of one agent performing actions on behalf of another one provided 1) the second one has the authorization 2) whose identity is authenticated by a third party trusted by the first one. This is more of implementation details compared to the above goals.

They are well known. These goals can be achieved using a combination of public key and symmetric key cryptographic methods, including encryption and authentication. The field has a long history and is quite complex. The following is a classification that may not have a clear boundary between them, but it does help the subsequent analysis for the sole purpose of presenting this invention.

At the basic layer, namely the first level, there are public key, symmetric key ciphers and hash functions:

1. Symmetric ciphers include DES (and it variants), Rijndael, MARS, Serpent, RC6, Twofish, IDEA, Blowfish, RC4, etc. and some stream ciphers.

2. Public key cryptosystems including RSA, Rabin, Diffie-Hellman DSS, ElGamal, Elliptic curve, LUC, XTR, etc.

3. Keyed or unkeyed hash functions derived from SHA-1, MD5, RIPEMD-160,Tiger, MD2, MD4, etc.

which are supported by random number generators and padding schemes. This layer are quite stable, robust. It is adopted a prior.

The next level are many established standards, formats, interfaces used to organize these basic cryptographic functions in such a way to achieve the above list of goals, at least partially. Typical of the later are

1. X.509 and pretty good privacy (PGP) Certificates.

2. Public Key Encryption Standards (PKCS)

3. IEEE P1363: Standard Specifications for Public-Key Cryptography

4. Pretty Good Privacy (PGP) Standards

5. S/MIME

6. Generic Security Services API (GSSAPI)

7. Microsoft CryptoAPI

8. Common Data Security Architecture

9. Lightweight Directory Access Protocol

10. etc.

Above this layer, namely the third level, are protocols that govern how information are exchanged in instances of cryptographic systems between computers using, e.g., intranet or internet. At this layer, the basic elements from the first two layers are combined in various forms to render it deliverable over the network layers to support the list of goals above. The differences between the current invention and these solutions begin to manifest at the second level.

At the IP level, there is IPSec, which can encrypt all data exchanged between any two machines with IPSec enabled. It provides strong and reliable security and machine authentication that is transparent to application programs. Depending on needs, this maybe good enough for certain applications. It is not good enough, however, to provide a flexible transport and/or application level support of entity authentication, controlled encryption and right protection that are interested in this invention. It also makes repudiation possible since there is no reliable way to bind the machine to an entity (a human user, for example).

There are many solutions at the application level. Here is an incomplete list (see, e.g., Refs. [3] and [4]) and a highlight of certain aspects that are considered weakness that can improve under an unified scheme, in addition to the new elements introduced, at the design stage of the current invention.

1. Domain Name Server Security (DNSSEC). It is used to secure the binding of the domain name and the underlying IP address(es) against possible DNS spoof Many other solutions are also DNS spoof resistant. It, by itself, is not enough for the present purposes.

2. SSH2 Protocol, persistent connection, may not be suitable for modern remoting and web-type of applications

3. Secure Socket Layer (SSL). The de facto standard of the current web security solution. The following aspects will be elaborated in the sequel.

(a) Client/Server versus Peer/Peer or Entity/Entity centric.

(b) Client Key management, hard, imperative versus declarative, user trust based.

(c) Machine oriented versus entity oriented.

(d) Initial hand shakes. Four ways versus one way to two ways. This invention differs from SSL and many other protocols in that it relies more on referencing to pre-existing records than real-time transmission of (“hard”) credentials or certificates. It thus allows “credit” accumulation.

(e) Centralized certificate management versus Hybrid (Local, Peer to Peer, Server oriented).

(f) DNS spoofing, possible, no real time check versus real-time random check and just in time check.

(g) Flat message format versus sectioned multi-authors with a possible arbitrator.

(h) Transient storage versus two kinds of permanent ones.

(i) One to one or any versus one to selected group or group escrow access mode.

4. Transport Layer Security (TLS). A refined version similar to version 3.0 of SSL. The problems this invention tries to address that are not well handled in SSL are still not addressed.

5. Secure Hypertext Transfer Protocol (SHTTP), not widely used.

6. Message (embodied in E-Mail at the present) security and related services (S/MIME, PGP)

(a) S/MIME requires the formatting of the message after security operations versus security operations after MIME formatting. The difference may originates from the server centric design of the S/MIME format and client centric one adopted here.

(b) Both of them do not authenticate the sender but only the authors through digital signature. The sender can be treated as a different entity from authors in this invention to accommodate the possibility, which may occur in processing legal papers/documents, like contracts, wills, etc., and in many others. In formal legal documents/papers containing one or more digital signatures, a third party arbitrator is required to prevent repudiation of a digital signature based on real and/or false claims to the effect that a signer did not produce the signature due to the lost of his/her private key. The sender, who should be different from and unrelated to the authors, can act as a witness or notary party for the fact that the digital signatures are indeed signed by the signers. In protecting digital products, the sender could also be the quality assurance department.

(c) Key management, no global scheme exist versus there is one. Global scheme is required in a scalable declarative solution.

7. Kerberos, not-public key, complex, centralize, non-scalable.

8. There are also various different flavors of local file encryption solutions that depends either on symmetric key ciphers, public key ones and the combination of them, PGP is an example of the last kind.

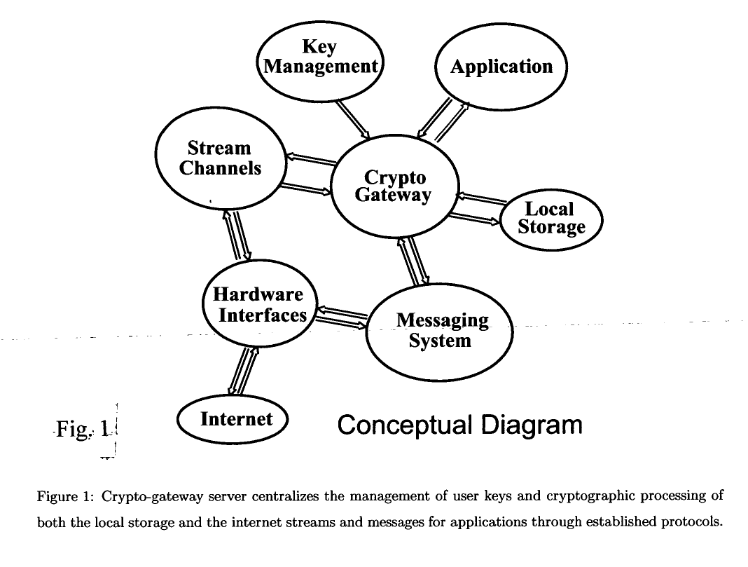

There are also the tricky problems of key storage, management and distribution. These are implementation dependent, sometimes secret or proprietary, no general standard seems to exist, different vendors and applications have different set of keys to represent user's digital identity, although they may use the same algorithm, these keys are very hard to be reused from one application or system to another. A good cryptographic system with the true ability of “Identification” requires an unified key management component since private keys represents a user's true digital identity. Identity should be useful anywhere, not bind to any software or machine. The fewer of the varieties in the same time period, the less confusing. It is intended to be solved, apart from other problems, by using an application level crypto-gateway server (see FIG. 1) that understands common protocols that are already established or newly developed. Such protocols comprise, e.g. HTTP and its extensions. Solutions exist that claim to be so convenient in use that a user does not even need any personalized password. It is not expected to be possible since information about personal characteristic can not be reduced, but the gathering of such information can be made easier using new technologies. The solution provided here comprises three or more piece of information to retrieve a private key contained in a key container. The container comprises of file, database record, hardware chips or devices. One to maximum of them can be related to a person's physical/chemical characteristics comprise finger prints, verbal or other biometrics characteristics, etc. The rest can be related to unique memory of a person, comprises access code, user name, password or passphrase.

Another area of current concern is the accessibility problem associated with certain secured contents. The possibility of lost or corruption of private keys, the departure of an unhappy employee who has the sole access to certain contents of group, corporate or government interests, the law enforcement agency who has a need to carry out authorized investigations, etc., require that there should be a mechanism to establish an alternative channel to access certain contents under the consent of the encryptor to protect his/her access right to the extend of certain policy accepted by the encryptor and other related people. A solution of it is to put some private keys of a user under escrow in the hands a group of trustees [5]. Key escrow has it's limitations because a private key serves multiple purposes. Putting a key under escrow implies that all contents secured by the said key can be accessed by the group of appointed trustees (together) for the key. Sometime this is too much a requirement. Many private contents, especially the ones whose value have a short life time and is of private nature, that a user would like to secure do not need to have such an alternative access channel. It is therefore better to have a content escrow means rather than the key one.

The existing solutions can meet some of these goals, not at the same time and under certain constraints that either lead to security compromises, having scalability restrictions and making inefficient use of the network resources. Some of these constraints can be removed given the available software and hardware environment today. It is to aim of the present invention to remove some of them by providing a uniform solution.

The presented invention deviates from the current approaches starting at the second layer by introducing a new set of message formats and a new key storage, management and distribution protocol framework and mechanisms. On the network layer, a supporting infrastructure is designed to achieve the security goals.

The new elements that are introduced in this invention are represented in the following categories

1. The key declaration and management scheme

2. Secured message format

3. Application layer gateway

4. Existing web infrastructure integration (proxies, content cache, . . . no design/implementation obstacles)

This will be explicated in the following.

### SUMMARY

To ourselves: “Who do I trust?” This is already a hard question even in real life, let along on the internet. But things can become better with this invention.

To others: “Who are you?” This is generally considered not a welcome question to many. It tends to drive curious potential associates (friends, users, etc.) away. Authentication nevertheless has to ask this question. The question is how to make it more acceptable. The declarative, just in time authentication system of this invention has the following merits

1. It is more secure against spoofing.

2. It protects a user's privacy.

3. It makes the reply of the above question more acceptable

“What do you mean by ‘Declarative’ or ‘Imperative’, don't play word game with me!” I am surely not. The term “Declarative” here means essentially declare first and proof it when needed base both on the credential supplied for the proof and on the past experiences about the claimed entity. The term “Imperative” here means proof it now and forget about it afterward. They differ in the sequence or order of operations performed in the authentication process and in credit building process. To give an example, Bob and Alice talk over a dedicated telephone line for important issues. One day the sleepy Bob was not sure who was on the other end when it rang, a conversation could proceeded like the following

Alice: Hello Bob.

Bob: Who is this?

Alice: I am Alice.

Bob: Hi, Alice.

Alice: It's nice today.

Bob: Yeah, indeed.

Alice: Could you send me $10,000 to the following address?

Bob: !!?? (awakened)

Alice: Because our department . . .

Bob: Sure, right away!

Alice: Thanks!

Bob: Good bye.

In declarative authentication process, Bob will check the credential he kept for the real “Alice” he know and ask this Alice to proof herself when she ask him to send the money and then send the money to a preestablished account between them, which he know it is sure to send, directly, to the real Alice from previous experience and resulting trust with the account. There will be no direct benefit for a fake Alice to trick Bob to send the money. But in imperative authentication process Bob will ask her to identify herself when he say “Who is it” and, if he want to be absolutely sure, he need to ask her to meet him somewhere in order to see her and hand the money to her in person. So in fact the above conversation never continue beyond the fourth line. If he becomes lazy, there could various holes on the implementation of the process to transfer the money to Alice by a series of third parties or middle men (servers, the potential holes). At least two weak points are opened

1. Since Bob's message is decrypted at each server, stored or re-encrypted (if it is done at all) and transfer to the next one. Question arises: how does anybody know who can access those plain messages while they stay on a server? As the internet becomes more and more complex and diverse, these intermediate “relay stations” will become more and more and they are also changing dynamically, there is simply no effective way of controlling all of them by anybody. If there is one, does anybody trust it or welcome it? If not, repudiation becomes possible.

2. Since Bob authenticated the identity of Alice at the beginning of the conversation and send the money after exchange a few casual conversations with Alice. There is time for a skilled eavesdropper to manipulate the authenticated connection by, e.g., IP or DNS spoofing to redirect the authenticated line to his/her server.

Such explorations, if occurred, can continue without the person behind it been caught since it is stateless. Of course the imperative solutions can incorporate some of the later features about the state, there are still other benefits that a declarative solution can be a merit.

Another benefit of the declarative authentication process is that if Alice never asked for the money, they could both have a nice chat on weathers, politics, and other fun stuffs without any interruption of the conversation. But in imperative one, the dedicated line could never be used for causal conversations, it is indeed dedicated. The web is not a dedicated private net, it is public one on which most of the stuffs are of the causal types. Some people even want to be anonymous when surfing it. Getting serious or getting real is only infrequent events. Therefore, it is better to have a stateful declarative authentication solution.

The above example is for illustration purposes, it gives the spirit but it could not cover the subtleties of the real design and implementation, which is elaborated in the following.

### DESCRIPTION AND OPERATION

a) Keys and Message Format

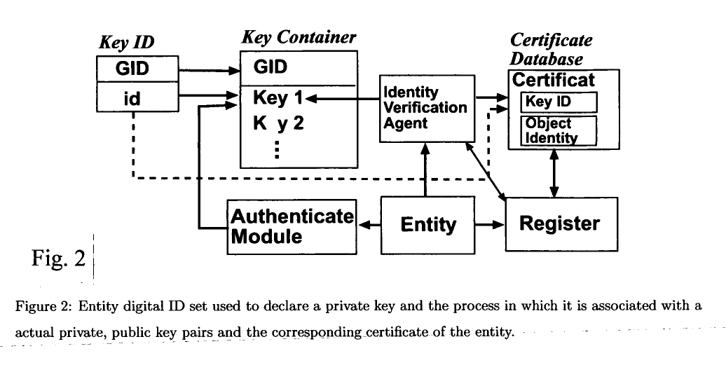

The public and private keys are stored in a list of corresponding virtual (they may occupy the same physical media) key container pairs as shown in FIG. 2. A crypto-gateway server handles multiple such kind of key container pairs that belong to different entities. An entity can be a human or other unique, not easily duplicable object, subject collection, aspect collection, etc. Such an interpretation of an entity is used in this patent. A list of properties that key box should have are given in the following

A KEY CONTAINER pair is access protected within the scope of an account using one or more access codes of arbitrary length so that a local entity (or owner) can not access other local key containers belonging to a different account. A selected hash function is used to generate the hash value of the said access codes, combined in a predefined mean. The said value is used as an account identifier for the entity on the crypto-gateway server. An account can contain more than one key containers belonging to one or more entities. An entity can access key containers of other entities in the same account, although it may not be able to retrieve a private key in the said containers if the said key does not belong to the said entity.

A KEY CONTAINER pair is globally identified by a global identifier (GID). A GID is an unique symbol or number for all user's of the system. The possible values of GID should span large enough space so that the system can be used globally. The GID field of the container is protected by cryptographic means using keyed hash function against accidental or intentional change of it, despite the fact that such a change can not lead to a real leak of a private key contained in the corresponding key container.

A KEY CONTAINER contains a list of private or public keys for the entity who owns the contains. A key pair in the corresponding pair of key containers are locally identified by an identification number (id), which is unique within the scope and during the live time of the container. In a particular realization, a key container is realized in media comprises a local file, a database table/field or hardware storage devices/chips, etc.

The private keys in a key container are encrypted using a symmetric cipher, like the AES, whose key is generated from a set of unique characteristics comprise a particular value in a user's memory, verbal or biometric information, etc. belonging to the entity. There is no need to store the said characteristics collections. In one embodiment of the invention, in which two pieces of unique entity characteristic information are required to secure or retrieve a private key, it is stored after been processed using steps comprise

1. Gather the two pieces of entity unique characteristic to generate two keys of desired length using a plurality of algorithms to enhance the randomness. If a generate purpose private key is to be secured, only these two pieces of information is used to generate the corresponding key pair. If a dedicated private key is to be secured, additional unique and reproducible environmental information to which the private key is bound to is also required to seed the selected algorithm(s) to generate the two keys.

2. Select a keyed hash function (e.g. SHA-1, SHA-256 or MD5) for the private key protection (sub)system. Using the hash function and the first key generated in step 1, compute the hash value of the private key.

3. Select a block cipher, e.g. AES, for the private key protection (sub)system. Encrypt the private key using the selected block cipher and the second key generated in step 1.

4. Pack the resulting values in steps 2 and 3 and store the whole data block, which can be preceded by a corresponding descriptive and/or historic header, in the private key container.

5. The said header, if implemented, can also be encrypted using an selected cipher with an application level key to prevent manipulations or spoofing. But the encryption is not essential to the security of the system.

The retrieving steps comprise

1. The program read two pieces of characteristic information from the entity who/which is trying to load the private key.

2. Read the private key data block, together with the possible descriptive header. If the said header is implemented, act base on the information contained in it.

3. The two corresponding keys are obtained by using the same algorithm as the one used in the securing process. If a dedicated private key is going to be loaded, retrieve the same kind of environmental information as the one used in securing the private key to seed the selected algorithm(s).

4. Decrypt the encrypted private key using the corresponding key and compute its hash value based on the other key using the same block cipher and hash function.

5. Compare the resulting hash value with the one stored in the data pack.

6. If the result match, then load the private key. If not, the load is aborted.

7. Record, if implemented, the retrieval action and result in the said header.

The system can be build to limit the failed attempts of retrieving private key to certain fixed small random number (e.g., around 10) after which further trial will be ignored. The records in a public key container contain not only the public key, but also other attributes that are private to the owner of the key which comprise

1. The usage of the key pair (e.g., signing, encryption/decryption, etc.).

2. The type of the key pair (e.g., general purpose, dedicated, etc.). A dedicated key pair is bound to fixed host, software or purpose. In protecting a dedicated private key, not only entity's characteristics collection is gathered, but also the “finger print or signature” of an associate object that the first one uses is also gathered and bound to the key. A general purpose key is bound only to the entity.

3. The list of remote databases (URL) where (and how) the corresponding key certificate is published and the current status of the certificate (e.g., uptodate or old).

4. Other public information in the corresponding certificate that is handy to be duplicated.

There is a corresponding certificate stored in a third (logic) container for each public key. A certificate is also identified by the (GID,id) pair for the key pair. There can be two kind of certificates

1. A normal certificate contains entity information comprise entity's name and many others commonly used ones (e.g., the ones recommended in X509 [6] and useful information about a persons communication channels) and one of a entity's public key. The preferred entity's name included in a certificate is a pre-established/registered, credible and already recognized name, like a human's legal name.

2. An anonymous certificate contains no personal information about the holder. The personal information is replaced by certain common information of a group. These certificates are used to provide the assurance that an unique member of a group exists (without showing who the individual actually is) for a receiving party of the certificate. Anonymous certificate can be used in situations where the uniqueness of the sender must be guaranteed without knowing the sender's social identity. In addition, the sender is able to verify the information he/she send to the receiver is what it is intended to be. An application is to an e-voting system where a voter needs to remain anonymous. The voter also must have a chance to verify his/her ballot after initial cast before it is committed. This will be described in more details in the following.

The combination of these information is protected by a keyed hash value with a common key and/or digital signature using an already established, trusted private key. The public container for entity's certificates are ready to be exported to local and public certificate databases. In particular embodiments, published certificates extracted from the said container can be stored in a plurality of format and media implementable located on certain machines across the internet. A certificate contains other information. A list of them is given in Table 1.

There are three different storage modes for a certificate that differs in its publication scope and the subjective trust information a peer can record in it: the larger the publication scope, the less subjective elements it can contain.

1. Local mode. This is considered the most reliable and also personal mode. It enables a user to establish his/her own web of trust[1]. User can assign their own trust levels to it. If the trust level falls below zero, user can choose to block communications with the holder also. User who would like to stay anonymous to all but only the close associates of him/her can use this mode to distribute some of their certificates via secured channels.

2. Remote associate mode. Users can choose to put their associate's certificate on certain remote personal account (like on a website) permanently or temporary. These certificates are almost like a certificate in the local mode, but they are usually, although not necessarily, a reference to the public certificates described below. There can also be copies of certificates in this mode that a user can manage his/her trust level of it. It's good for users who are frequent travelers.

3. Remote public mode. There is a remote public directory for all published certificates for a software to search. The trust level inside all certificates in this directory is neutral, since they are public.

TABLE 1
A list of the attributes for a key certificate.
Other fields includes the actual public key, the digital
signature, etc . . .

| Attribute | Description |
|---|---|
| Version | The version number of the certificate. Making backward |
| | compatibility of this version in the future |
| | versions possible. |
| Attributes | A collection of entity's name and other attributes described |
| | above formatted in plurality of ways, comprise special |
| | character delimited name/value pairs or xml. |
| Key ID | The identifier of the key pair. For example, the (GID, id) pair |
| | for the corresponding public key. |
| Key | Public key cipher used (like RSA), the length of the key |
| Properties | (512, 1024, 2048, . . .) the creation and expiration time |
| | of the corresponding key pair, the status of them, etc . . . |
| Trust | A subjective, accumulative trust level assigned by the local |
| | user of the certificate. The level is measured in numbers. A |
| | certificate obtained from an external source, especially from a |
| | public certificate database, is initialized to trust level 0. |
| Class | This is a trust level assigned by a third party. Typically a |
| | user who signed the certificate. It is however not a measure |
| | of how this third party subjectively trust the certificate, but a |
| | measure of how the process of validating the claimed identity |
| | of the certificate's holder is performed, using objective and |
| | standard procedures. |
| Net | E-mail address and various other (optional) channels that can |
| Channels | be used to locate the holder of the certificate using, e.g., |
| | e-mail, cell phone, instant message, i.e.. |
| Source | The original source from which the certificate is imported. |
| URI | |

There is also a public accessible remote revoked certificates directory for user to announce the revocation of their certificates due to certain reasons and the corresponding list of reasons. Next, the encryption/decryption of data is described.

A cryptographic processed document/message/data, which is called a document in the sequel, contains a header and a body. There are two packing mode:

1. Packed mode, in which the document contains the header at the starting position and the body in the following position. This mode is best used for one to one peer to peer communication. It is more secure.

2. Separated mode, in which the header, which is a major component used to construct a secured link, and the body are stored separately. This mode is best used to construct various security enhancement schemes described in the following, including the one to many content publication or escrowing.

The header contains information about a session key for a symmetric block cipher, public key information of the sender and receiver. It is compressed and encrypted to protect the header integrity and privacy of both the sender and the receiver (against tracing). Table 2 contains a more detailed list of the items in the header.

The body contains a non-separable mini-header and the content. The pre-encrypted mini-header comprises information about the padding, serial number, version number of the document. The mini-header is encrypted using the said session key. Bytes from encrypted content of the mini-header, which to a large degree quasi-random, and from the header session key are combined to seed a deterministic algorithm to obtain a new block cipher key to encrypt/decrypt the body content that follows the mini-head. This measure is needed to prevent dictionary attack when an old version of document is upgraded to generate a new version in the said separated packing mode since different versions of a document is accessible by an identical set of access tokens (or virtual secured links) discussed in the following.

The body content is constructed in three different formats:

1. Random sectioned format. It is used mainly for readable text documents. It is explain in more detail in the following.

2. Blocked format. The body content is divided into fix sized chunks, which are encrypted and possibly digitally signed. The resulting chunks are packed together in the same order as the original ones to generate the output. It can be used for any type of document and network streams.

3. Stream format. It can be used for any type of documents or network streams encrypted/decrypted by a stream cipher. The content of it can not be digitally signed.

A text document processed using random sectioned format contains two kinds of sections before encryption is performed

1. Plain text sections of zero or a finite length followed by

TABLE 2
The header for a secured document comprises the following fields

| Attribute | Description |
|---|---|
| Version | The version number of the header. |
| SenderID | The (GID, id) for the corresponding key of the sender used in sending the message. |
| ReceiverID | The (GID, id) for the corresponding key of the receiver used to read the message. |
| Session Key | The session key for a symmetric cipher used to secure the document, which is |
| | encrypted by the sender's private key and selected public key of the receiver(s) |
| | using certain padding scheme. To realize the one to many(AND) access control |
| | described in the text, there can be more than one receivers. When decrypting |
| | the document, the order of operations is reversed. The system first authenticate |
| | the receiver or receivers (in the reverse order relative to its production), if ok, |
| | load (each one of) the corresponding private key to decrypt the encrypted session |
| | key data which is further decrypted by the sender's public key find in the user's |
| | local, remote private certificate database or from a public certificate directory. |
| IV | The initialization vector for the document. |
| Time Stamp | The date of creation. |
| Expire date | The date after which the header expires. |
| Return date | If the user's access right for the secured document is checked out (see the following), |
| | the returning date of the access token described in the following. |
| Access | Specifies how the corresponding access token in the separated packing mode can |
| | be used to access the corresponding content. It comprises of READ, WRITE, |
| | CREATE, DELETE, etc.. |
| Max Length | The maximum length that the content can has in various versions. It is used |
| | mainly in separated packing mode where the “content” is treated as a container |
| | or template that hold different kinds of contents. In this case, there can be a |
| | desire to implement a policy to enforce a upper limit restriction for the actual |
| | content. |
| IsOriginal | A flag indicating whether or not the corresponding access token in the separated |
| | packing mode is recoverable or not. In the chain of leases (see the following) of |
| | the receiver end, only the copy of the access token of the original owner has this |
| | flag set to true. It is set to false in all other copies. |
| Validate Code | A pre-set code that is used to test whether or not the session key recovered from |
| | the encrypted one contained in the header can correctly decrypt the content or |
| | not by compare it with the decrypted value of the mini-header of the body. If |
| | not, the main body of the content is not processed any further. |

2. Secured sections of zero or a finite length.

They are repeated zero or more times. The secured section contains further two parts

1. Zero or one digital signature for the text of the secured section by its author.

2. The text of the secured section.

Different secured sections can be digitally signed by different authors who are responsible for the corresponding section of the text. It can also be unsigned. The secured section can be encrypted or not after crypto-processing.

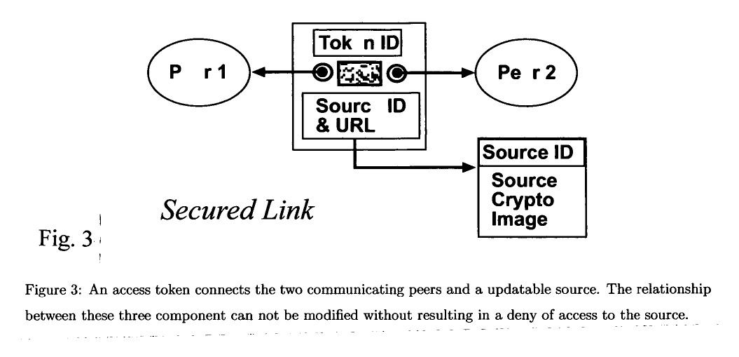

In the separated packing mode, the document header described above is encapsulated in a data structure, called access token or secured link (see FIG. 3), which can be stored in various media comprise a file, a storage location in hardware chip/device, database tables, etc. The access token contains further attributes comprise the items listed in Table 3.

As shown in FIG. 3, the access token acts as a three ends secured link that connects the sender, the receiver(s) and the source body crypto-image. The relationship encoded in the access token is in general not spoofable under the condition that the symmetric cipher and the public key algorithm used to protect it is not systematically broken in general. A crypto-image of a content can be linked to by multiple access tokens owned by different receivers (the sender end, which is usually the producer/arbitrator of the content, is a fixed one), so that a content prepared in the separated packing mode can be accessed by multiple users who has their own corresponding access tokens at the same time.

There are two kinds of access token, depending on whether the receiver end of the access token is specified or unspecified:

1. Private access token. The receiver end is specified. Only the specified receiver(s) can access the content using the corresponding access token. If the number of the receiver is greater than one, all of the receivers specified must be authenticated in a specified order before access is allowed.

2. Public access token. The receiver end is not specified. Anyone can access the content using a public access token, provided it exists. Public access tokens can be used in various situations in which only the sender and content need to be authenticated. Such situations comprise

(a) Server authentication: the user would like to authenticate an server application while remain anonymous for convenience or some other reasons.

(b) A publisher who want to have their content previewed by potential users before requesting for permanent ownership (or long term lease) can issue fixed timed public access token for potential users to download. The copy-protection subsystem allows such kind of token to install only once within a certain time frame starting at the installation time.

(c) etc.

TABLE 3
Essential data fields in an access token.

| Items | Description |
|---|---|
| Version | Version number of the token. |
| Type | The type of the content comprise EXCUTABLE, DATA, |
| | AUTHENTICATION DATA, etc.. The authentication data type |
| | is used as initialization data or program scripts of certain right |
| | protected executables. This type of access token is generally not |
| | displayed. |
| Serial No. | Header serial number used to identify the access token. It is |
| | used in various situations: 1) Private and/or real-time peer |
| | to peer communication or web-services (see the following) 2) |
| | Access multiple crypto-images of the same content, e.g. the $1 bill of |
| | digital cash (see the following), etc.. |
| Source Serial No. | Serial number of the crypto-processed source. It is used to |
| | validate the corresponding source in a conservative spoof resistant |
| | way. Conservative here means to treat any mismatch |
| | as invalid, the software does not try to recover from it. Spoof |
| | resistant is possible since the source serial number in the body |
| | mini-header is encrypted using the secret session key, there |
| | could be no consistent way of modifying both of them to have |
| | it point to a wrong source without knowing the session key. |
| Source URI | The URI of the source. |
| Owner | The owner of the access token. |
| IsCheckedOut | A flag used to indicate whether or not the access token is |
| | checked out. This number is used as a declarative flag. The |
| | true status is contained in the encrypted header, as indicated |
| | by the return date, which is checked when “it matters”. |
| Header | The encrypted document header described above. |
| Hash | Hash value of the encrypted header used to ensure data integrity. |

There are also two modes, which changes during the access token's lifetime (see the following), for an access token

1. Original mode: an access token in the original mode is allowed to be recovered if corrupted. The access token is in the original mode if its owner obtained it from a producer/arbitrator.

2. Duplicate mode: an access token in the duplicate mode is not allowed to be recovered if corrupted. When an access token is leased out, the one the borrower obtains is in the duplicate mode.

Separated packing mode for a secured content provides a plurality of different access control scenarios categorized in the following

1. Exclusive access (one to one relation) mode in which the content can only be accessed by one entity. This is realized by issuing only a single private access token by the producer to the designated entity. As described above, this is not the best situation where separated packing mode for a content can be used. The best packing mode for one to one access is the packed mode.

2. All access (one to all relation) mode in which the content can be access by all entities who use this system. This is realized by distributing public access tokens. Content prepared in packed packing mode can also be in all access mode.

3. Selected access (one to many(OR) relation) in which any of the selected entities can access the content. This is realized by issuing private access tokens to each one of the selected entities. This access scenario can only be realized by using separated packing mode.

4. Mutual access (one to many(AND) relation) in which the content can only be accessed if all of the entities, which are also authenticated, in a selected group must agree to access the content. This access control is realized by set all the members in the selected group as the receivers.

5. The combination of 1 or 3 and 4. This more sophisticated access control could be used to provide restricted normal access to the content to only a single entity or selected ones and leave an additional channel of access available to a group of trustees when needed.

Since a final access token is used in various situations described in the following, the production of it and the corresponding content crypto-image should fit into various application level requirements. It is expected that there are at least the following possibilities that have to be handled during the production

1. Brand new content crypto-processing. The access tokens and the crypto-image of the content are new with new session key, token ID and source ID.

2. Session key inheritance. Session key inheritance is required when producing a large collection of separated contents, like static web pages, using the same session key when these large collection of content can not be produced in one batch run. Session key inheritance is used to increase performance.

3. Content updating. As it is described above, when a content is said to be updated, there is no need to update the users' access tokens for that content. Therefore, when a content is updated, not only the session key is inherited but also the source ID.

There is an expiration time after which an access token becomes invalid.

An copy protection sub-system for the access token is developed [7], so that an access token, which acts as a virtual secured link between two communicating peers concerning a particular source or source container, can not be copied. However, the receiver end of the virtual secured link can be leased or transferred to another entity under certain agreement between the first owner of the end and the would be new owner of it. The leasing and transferring actions have different effects on the access token

1. Leasing. Leasing an access token to a different entity disables the access token of the original owner until the return time of it set in the lease terms. It has two limitations

(a) The time that the access token remains valid for the borrower must be not greater than the expiration time or the original return time of the access token before leasing to him/her. The later case applies if a borrower of the access token further lease the access token to a third entity.

(b) The mode of the access token for the borrower is set to the duplicate mode (see above).

2. Transferring. The right to the access token is completely transferred to the new owner. The original owner no longer has the access token in his/her storage. The mode of the access token is preserved. For example, the new owner acquires the access token as if it is from the original producer/arbitrator if the access token's mode is in the original mode (see above). If the “new owner” already has such an access token in a different mode, the more privileged mode of the two prevails. The later case happens when an entity transfers the access right to himself or herself, e.g., when going on to a trip with the return time hard to be predetermined.

The crypto-image of the content pointed by the access token can be updated by the sender without updating the access tokens in the hands of the users of the content. Each time the content is updated, its version number is increased by one. The sender can also choose to issue a new set of access tokens for a major change of the content. Each of the old users of the content needs to replace his/her corresponding token set in such a major change. Since the access token is protected against direct copying, a user must use the lease and transfer mechanism of the system to transfer his/her access right from one of the copies of his/her crypto-gateway account on different machines by treating himself/herself as the new receiver. If a receiver is done with the access token before the returning time is reached, he/she can transfer the access token back again. The most prevailing mode of the access token will be preserved.

The possible categories of application in which an access token can be used comprise

1. Publication of digital contents and executables.

2. Group collaboration.

3. Secured peer to peer communication.

4. Authentication and security in web-services.

5. Server side authentication.

6. Digital cash [8] (e-cash).

7. Online electronic voting system.

Detailed implementation steps are given in the following.

b) The Crypto-Gateway Server

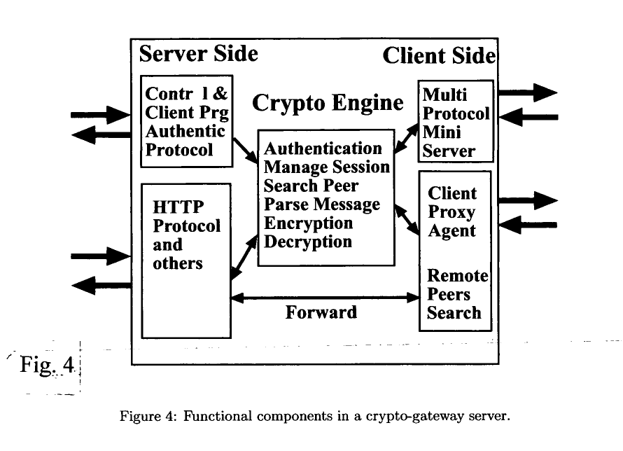

FIG. 4 shows the basic components of a crypto-gateway server. It is essentially an application server in a secured environment of a stand-alone computer or local area network (LAN) of the user. It authenticates the client programs, accepts the control commands from and send notifications to them. The client use it as a proxy when secured communicate with the outside is needed using the same set of protocols as the ones if the client communicate directly and not securely to the outside world. To the outside, it is essentially a multi-protocol aware client that forward the client requests and receives the results back. There is also a basic server component to the outside that are mainly used for private peer to peer authentication, filtering and communication.

In the middle of these two sets of component, there is a cryptographic engine component with variety of functions that handles the user authentication and the encryption and signing or the decryption and verifying of messages from both the inside and outside.

The crypto-gateway server operates in two modes (named from the perspective of the client software)

1. Active mode. In the active mode, the user of the client software initiates data retrieval by clicking buttons and/or hyper-links. This is what a client software typically do without a crypto-gateway server.

2. Passive mode. In the passive mode, the crypto-gateway server initiates the data retrieving and send the outside response to the client software, which acts as a dumb receiving device. It offers additional features comprise

(a) Broadcasting or multicasting. Since a crypto-gateway server can serve multiple client software at the same time. It can broadcast a piece of content data to a selected group of connecting clients. A concrete example of its uses is in a classroom setting where the teacher teaches base on certain digital content to a group of students in a local area network environment where each student has his/her own computer and the teacher can use the control over a selected crypto-gateway server to display the contents to student. The student can choose either to “listen” to the teacher or block it so that he/she can browse to other page of the content when needed.

(b) Passive data retrieving from a peer in peer to peer communication.

The “Control & Client Program Authentication” component communicate solely with the client software. It is responsible for

1. Authenticate the client software. Since the architecture is designed around distributed settings between the client and crypto-gateway software and the clients communicate with the crypto-gateway server in commonly know protocol (comprise, e.g., HTTP), many explores of such a setting within the user's local network becomes possible. To avoid abuse of such a possibility, the client software's signature must be recognizable by the crypto-gateway server. The crypto-gateway server contains a list of registered shared secrets between them. During the client communicates with the crypto-gateway server using the common protocol, the later issues random cryptographic challenges to the client and compare the response returned. The client software must encrypt the challenge using a shared secret key and send it back. The communication will continue only if the answer received is the same as the one that was originally sent out after decrypting the response using the same share secret key. The authentication challenge in the middle of communication is emitted at random times. During the first visit of the crypto-gateway server after a running instance of a client software is authenticated and temporarily registered inside the server database, an unique security session will then be established for it and the authenticated registration record is transfered to the particular session variable while the original one erased. In actual implementations, the order of the session establishment after authentication could vary. The said security session is described in more details in the following.

2. Secure communications with the client software. Since the crypto-gateway server acts as a proxy for the client, it share some of the client's credentials with the outside internet at large. To prevent local peers to intercept the user's credentials, such credentials are exchanged between the client software and the crypto-gateway server in encrypted form and they are decrypted to the “original form” before been passed onto the internet. The “original form” here means whatever form the client would exchange with the server software on the internet when the crypto-gateway server is not involved, the server or client could have already encrypted them. The crypto-gateway server do not try to use or interpret these credentials, it builds a new layer on top of them. The messages, whether they are secured to the outside internet or not, are exchanged between the client and the crypto-gateway server in plain form since the major cryptographic processing are done in the crypto-gateway server. Therefore choose the smallest local area network possible in setting up a secured environment according to the purpose of the application.

3. Accepting control commands from the client software. Many of the control commands can be embedded in the HTTP protocol using web-form pages if the client has the web-browsing capability. The ones described here are not related to the visual information that can be handled by the web form pages. The control messages do not contain the word “HTTP” in the first line to distinguish them from HTTP messages. Control commands are used to control the crypto-gateway server to perform actions comprise

(a) Client initiated session establishment. A running instance of a client software send a “hello” message the first time it tries to contact the crypto-gateway server telling it information about itself. The crypto-gateway server then send an authentication challenge to the client software. If client software is authenticated, a security session is established for it and an “session established” notification is send to the client software, together with the corresponding session ID. Hello message contains information comprise

i. The “HELLO” message as the first line (terminated by x0D0A or carriage-return and line feed escape sequences).

ii. The IP address and port number of the event accepting server (see the following) of the client software.

iii. The software ID.

iv. Destination domain name that the client software is interested in accessing.

(b) Client expiration notification. Client software should implement a expiration mechanism to handle idle user interaction scenario to increase security. When the client software determines it is time to expire, for reasons like the user idle time passed a preset value or the running instance of client software is stopped, it send an “expire” message to the crypto-gateway server, which in turn, expires the corresponding security session for it, if the session is not already actively expired (the crypto-gateway server also has its own auto expiration mechanism for idle sessions). The expiration message comprise the following information

i. The “EXPIRED” message as the first line.

ii. The session ID of for the running instance of the client software.

(c) Personal key management control commands. Some of them can be embedded into the HTTP messages when the client software is a web-browser using web-form pages. It can also be included in the message header by extending the HTTP protocol.

(d) Peer management control commands. Some of them can also be embedded into the HTTP messages when the client software is a web-browser using web-form pages. It can also be included in the message header by extending the HTTP protocol.

4. Notifying the client software of events. The client software must also implement a mini-server to accept event notifications from the crypto-gateway server. Notification messages comprise the following types,

(a) Authentication challenges. These are events that the client software must reply according to the shared secret between the crypto-gateway server and the client software.

(b) Data notifications. In passive mode described above, the crypto-gateway server initiates the data transfer to the client software by first sending a data available event message, to which the client responses to send a retrieving request. The message should comprise the information about.

i. Type of the data.

ii. Identification of the message to be retrieved.

iii. Crypto-gateway server listening IP and port number.

(c) Session established notifications, together with the session ID.

(d) Alter browser event that instructs the client software to change default browser component, which has more graphical capabilities, to a more secured version/mode of it to enhance security when sensitive data is expected to be passed to the crypto-gateway server so that some known security weakness of the operating system can be handled, if possible.

(e) Key management response information.

(f) Peer management response information.

The common protocol component understands and makes use of the standard protocol to accomplish the following tasks.

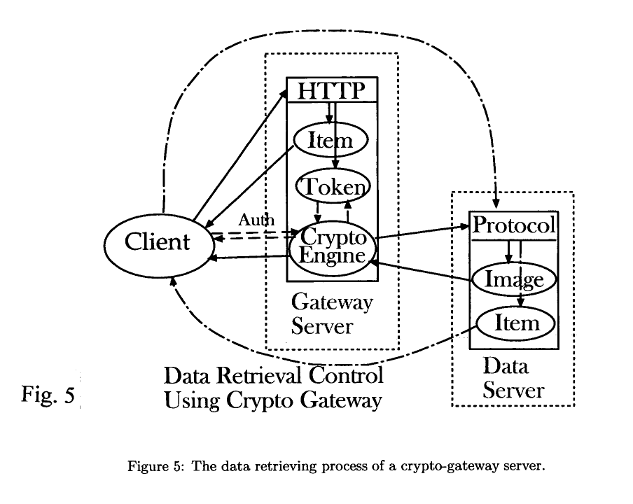

1. Have the crypto-gateway server to retrieve and send contents or messages from or to the outside internet after processing, as shown in FIG. 5. When retrieving, these contents or messages could also be local cached copies. Depending on the security requirements, the cached copies can either be the ones before decryption or after decryption or both. Mechanism can be implemented to make intelligent use of such cached ones. The crypto-gateway server should not try to manipulate the cached copies along the way outside of secured zone of the crypto-gateway server (like, on some remote web-proxy server or in storage of other cache service providers). This is left to be implemented by the client or server software. It does, however instruct the client to turn off its own local cache, if any.

2. Control the crypto-gateway server to perform various tasks comprise personal key and peer certificate managements.

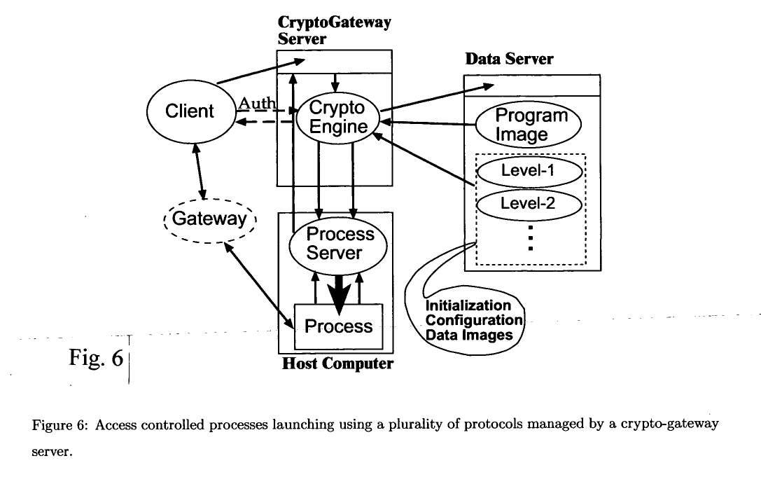

3. Lunch right protected, digitally signed application software via a process server through the client software on the crypto-gateway server side of the computer. This is going to be described in the following (see FIG. 6).

4. etc.

The major protocol to realize the above task is HTTP. In implementations where the HTTP protocol is kept unmodified, this component is essentially a combination of a web server that recognizes special tags contained in the incoming and outgoing messages. These special tags are primarily consistent with or contained inside of the existing HTML (or XML) ones. Since the end point processors of the message are not expected to understand or process these tags, they are removed or recovered to conventional ones after crypto-processing. The producer of the source content, which in case of web contents are the web pages or web form pages, is responsible for putting special tags in their contents so that desired security policy can be enforced.

The crypto-engine in the middle of FIG. 4 is responsible for all the crypto-processing of the messages running in both directions. It manages a set of session variables corresponding to each of the running instances of the same or different client softwares. This component can be further divided into sub-components comprising

1. Proxy component, in which the data streams and their headers are essentially unmodified when passing through it.

2. Messaging component, in which the data stream is prepared using packed packing mode and is encoded by means comprise compression/decompression, base64 encoding/decoding, etc., and is processed by the crypto-engine in whole before passing to and from the client software during which the header of the data stream -could be modified according to security policy.

3. Streaming component, in which the data streams are crypto-processed, preferably in parallel, and blocks of the processed data are send to the client software whenever they are ready. The headers of the these data streams could be modified according to security policy.

The messaging component handles messages in packed packing mode that are received from external sources by a client software inside or send out by the client software to external sources. The crypto-processing of the body of a message contains extra encoding or decoding steps in addition to encryption and decryption. After a private key for the sender is loaded, the steps involved during encryption comprise

1. Compression by a chosen compression algorithm.

2. Encryption and digital signing by chosen ciphers, where the signing can be optional.

3. Compression again. This step is optional since encrypted data are normally random enough so that compression is less effective.

4. Base64 encoding.

When the message is decoded, if the required receiver's private key is not loaded in the security session for the receiver, a load key dialog with the reader is initiated by the crypto-gateway server to input necessary reader characteristics (e.g., username and passphrase) so that an attempt to load required key can be carried out. If the key is loaded, the order of steps to proceed is reversed compared to the encoding ones.

The crypto-gateway server maintains a mini-message database for each session so that these messages can be forward outside or inside immediately or in an asynchronous manner. An automatic clean up mean for these message databases should also be implemented.

The streaming component is more complicated compared to messaging one. For incoming message request, shown in FIG. 4, perform the following pre-processing steps,

1. If the request is made via an access token stored in the designated directory (see the following), check the availability and validity of the access token. An access token is invalid if any one of the validity attributes are false, else go to step 2 in the following. Such validity attributes comprise

(a) It not corrupted or tempered with which renders its digest signature check fail.

(b) Whether or not it is expired

(c) Whether it is checked out.

(d) Whether or not it is the valid unique copy.

(e) etc.

2. Provided that the previous steps succeeded, find the session variable corresponding to the request. If none is found, create a new session and notify the client software of the new session ID.

3. Allocate a new or book an existing channel thread or process in its resource pool to handle the potentially valid request. The booked of the channel is kept in such a state within a fixed amount of time. If it is not picked up after the said time, the channel thread will be released to the available list. Attach the session variable to the booked channel.

4. Check if the requested access is public or private.

5. If the access is private, check the session variable to see if the user has already had the required private key loaded. If not, push the variables relevant to the request into storage associated with the session variable and return an authentication form page that contains the required key ID (GID,id) to the client software to let the user to enter the corresponding user name and passphrase or let the client software automatically sample the users biometric or finger print information. After the said form page is posted back, either by the user or automatically, the crypto-gateway server extract the returned information to load the required private key. If the load fail, continue the dialog a few times before reject the request.

6. Suppose that a valid user private session key is loaded on the crypto-gateway server now. If it is the result of an authentication dialog with the user, pop up the request information from the corresponding storage associated with the session variable, else continue. Next analyze the request so that information pertaining to inside of the LAN get removed and the user credentials, if any, appended. Then forward the request and wait for the response.

7. Upon receiving the response from the remote server, analyze and process the header. The processing comprise the following steps

(a) Remove any cache instructions if there is any. The client software is not supposed to cache the plain version of the contents that are secured. Caching for secured content must be delegated to the crypto-gateway server where the secured copy is cached, if needed.

(b) Extract information about the content, like the length, format, media type, key used,

(c) Get the server side and client side sockets for this particular request that is going to be used by the booked processing channel.

8. Feed the processing channel with the required information and set it run. In the mean time change the booked status of the processing thread or process to running status.

9. The processing channel search sending peer's certificate in local peer's database. If so instructed, block the ones with a negative trust value. If the peer is not found, check the registered remote databases that contains peer's certificates. Two kinds of remote certificates are searched according to the order presented in the following

(a) Personal associates. Known peer's certificates who has established a personal association with the user.

(b) Public ones. Those are the ones that are not associated to the user. Their trust value is not established despite the fact that some of those certificates were signed by a trusted CA or peer who performed extensive check on the identity of the persons behind the certificates.

10. Using the information gathered, check the validity of the source (see above) before actually start the bulk processing. If the source is valid, which implies, apart from others, that the loaded session key or the user behind it is valid, then start the bulk processing of the content data stream coming from the server and deliver it the the client software. Log start time.

11. The above processing include steps comprise

(a) Check to document ID against the one claimed one in the access token or (url, in case of url access). If match, compute a key for the chosen block cipher using this information and the session key using a chosen deterministic algorithm.

(b) Parse the incoming messages to find secured blocks and digital signatures within.

(c) Decrypt the block. Verify the signature, if present, after search and acquire the signer's corresponding certificate either locally or remotely (see above). Save the outcome of checking in a signature check status list array.

(d) For messages secured using random section format (see above), call a default formating procedure. If there are registered call backs, call them in sequence to format the output according to the specifications. The default formats comprise

i. Raw, which is the internal format

ii. Plain, in which the actual digital signature is replaced by a status indicating the success or failure of the check performed on digital signature. It is formatted in a way that is more readable.

iii. XML, which marks various sections of the secured message blocks using XML tags for the next level processing.

(e) Send the ready blocks to the clients on the fly. The plain text sections in messages secured using random section format is always ready so they are send as soon as the internal buffer is filled.

(f) Flush the remain content in the internal buffer after completing the receiving from the server.

(g) Close both end of the communication and clean up some resource. Log the finishing time, register other channel statistical data. Set the status of the processing channel to ready.

12. After successful processing, the crypto-gateway server send a notification of the availability of the signature check list and the list of corresponding peer's certificate information, formated in proper way (like in xml or html), to the clients for it the pick up.

The right hand side of FIG. 4 contains two subcomponents that connect to the external internet. The client proxy agent is responsible for forwarding requests from the client and receive the response messages.

A HTTP proxy has the ability to analyze the HTTP header of the response message and take appropriate actions depending on the header based on the following three broad classification (according to RFC 2616 [11])

1. Normal response. If the request requires the crypto-processing, it will forward the response to the crypto-engine after the header analysis described above. The crypto-engine will take over to act as the proxy between the outside server and the inside client. If the request does not require the involvement of the crypto-engine, it forward the response back to the client, like an ordinary web-proxy.

2. Server redirect responses. If the server initiates a redirect instruction to the client software, this component extracts necessary information from the message and notifies the client software of the redirect instruction along with the needed information.

3. Errors of various kind originate both from the server and client. Error messages are forward directly back to the client software without filtering.

The multi-protocol mini-server is responsible for accepting active request from the external internet. It acts as a server with limited functionalities and resources designed mainly around serving small static access point files (see the following), accepting and processing posted data related to security that are used for peer authentication purpose described above. It can be used as a front end to authenticate incoming requests for web-services behind the crypto-gateway server. For safety purpose, it can be run in different, expendable processes from the crypto-gateway server that can be respawned if needed. It need to have a detailed log, auditing and filter components for incoming calls and a smart response mechanism to detect irregular behaviors of a particular source or entity.

For outgoing form post messages that are directed to the crypto-gateway server. It performs the following steps before forward a posted message out to the remote server. The steps that are not already explained above are

1. Check if the user of the client software had already established a security session. If yes, let the user know that he/she has the option to change the key. Then pick and load one of user's selected private key into the session variable. If not, prompt the user to do so.

2. Analyze and process the request header according to the above description. Check and clean up the unused portion of the send buffer to prevent leaking of sensitive information.

3. Parse for and inspect each field in the posted data area looking for field names that are prefixed with predefined tags, e.g. “secure_” or “auth_”, “sec_update_”, etc. for server authentication. The server side software is responsible for generating these prefixes according to policy or user interaction or selection and display these fields in a outstanding way. The user who find inconsistency of their choice and the display should be instructed to stop the data post.

4. For each tagged field that are instructed to be constructed using packed packing mode, encrypt the value of the field using that packing mode designated to each of the receiving peers specified to the crypto-gateway server by the user. Join the n copies (n is the number of receiving peers) of encrypted value, together with the sender and receiver information, to replace the original value. XML tags can be chosen to delimitate various components of each one of the joint copies of the resulting value of a secured field. The server is supposed to be responsible for recovering the n copies of each secured field once the posted message is received using the information contained in the XML document for each secured field.

5. For each tagged field that are labeled as an update of existing content, extract the access token, check if it has the WRITE permission, if yes, process the updated value and replace the value by the outcome of the processing, else stop the posting and send an error message back to the client software.

6. It is recommended to remove the prefixes for each tagged field name and pack the resulting fields in the posted body data in the same order as they are received. This depends of course on how the server side software handler is implemented.

7. Forward the resulting post message to the remote server.

8. Redirect the client to the resulting page according to the response of the post request. The redirect should be initialized by the server.

The following are a list of security measures with increasing security in posting data to web-servers

1. In order to prevent the form page to be manipulated on its way to the client, the to be secured fields should be clearly marked, the marking should be checked by the client software, which can search the special tags and be smart enough to find inconsistencies in the page.

2. A simpler solution would be to secured the post form page using public access mode.

3. The user should be able to manually or automatically check the server authentication during the input (see the following) when posting unsecured data.

4. Better yet, a script can be written in the web page for the form to check the authentication of the server before posting the data.

5. If even more security is required, use the just in time security protocol for web-services described in the following to accomplish the task. This requires programming beyond web-page one.

In addition, the message component can be used to deliver peer to peer secured messages formatted in packed packing mode through one of the configured external message delivering/routing servers for each user's account. These external message delivering/routing servers comprise the ones that understand SMTP and the mobile device gateways on top of them, the IRC, ICQ, instant messaging systems, the possible central message delivery system of a website, etc. Since a secured message is base64 encoded in the last step, it is a simple text file in the view of these messaging routing and delivering servers.

These external message channels are also used to deliver various services pertaining to this invention. Such services comprise the following

1. Peers certificates prepared in either conventional or secured format. The conventional channel of peers certificates delivering is required at the initial stage of a new peer association establishment. After such establishment, a pair of two peers can choose to send their other certificate in either conventional channel or secured channel. The later channel is useful if the two would like to establish a private line that is in principle not exposed to the external internet (see above) besides the two internet access (delivery and receiving) points.

2. Key boxes. Empty key box with unique global identification number (GID) can be delivered to a user's account in secured channel (mainly for the purpose of maintaining message integrity and receiver authentication). Since these key boxes are ordered from central servers, which do not actively communicate to the user, the initial ordering can be done using local keys with an identical null GID. The corresponding certificate with null GID is not further used by the server after processing the order.

3. Key box collections. Large amount of key boxes packed together can also be delivered using secured channels to a user.

4. Access token and/or their collections from the content producer can be delivered to user account in secured channels (for the same purpose as above).

For performance reasons, some of the important and frequently used resources, especially those large objects, are registered when they are created on the heap. They are not deleted after been used but are cached in resource pool for later reuse. Typical examples are the server side handler (class) of the crypto-gateway server, which is relatively large due to its complexity and tends to be numerous for complex web applications, are kept in a pool for a period of time after been closed. This pool is checked before new handler object is created. If more than one available handler objects are found, the one that are used latest is selected. A low priority background thread is created to continuously delete resources that are not used after its corresponding predefined expire time.

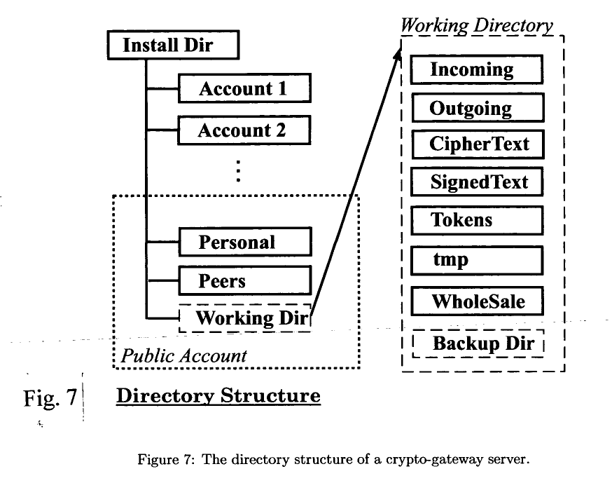

The installation and user account files are stored in chosen directories for a crypto-gateway server. The root installation directory is specified in the installation process, under it are directories for private personal accounts. Each one of them has three branches of directory roots that can be setup. They are shown the FIG. 7. A public account of the same structure as the private ones is located in the application root installation directory.

1. Application Root Directory: Under the installation (application) root directory, there are subdirectories for the public account and a list of private accounts of the same structure

(a) (Personal) subdirectory, which is used to keep the personal key database files or virtual files that link to other type of storages or databases.

(b) (Peers) subdirectory that is used to keep the peers certificate and user's own certificate database files or virtual files that link to other type of storage, including local or remote storages or databases.

(c) One or more private user accounts that has the same structure as the public one described here.

2. Working Directory Root: The default working directory root is located in the same directory as the installation root directory. It can be set to point to elsewhere. Under the working directory root, there are four subdirectories:

(a) (CipherText) subdirectory is used to store encrypted files that are public or crypto-images for contents packed in separated packing mode.

(b) (SignedText) subdirectory contains the files saved after doing digital signature.

(c) (Outgoing) subdirectory contains securely encrypted files belong to different receivers. Most of the file here is not recoverable by the user if he/she is not the designated receiver.

(d) (Incoming) subdirectory contains saved secured incoming messages from the messaging component (see above).

(e) (Tokens) subdirectory contains access tokens used to access crypto-processed digital data.

3. Backup Root Directory: This directory is used to hold backup(ed) keys and peers database. The backup is done automatically each time the crypto-gateway server exits and can be done manually or according to a schedule. It is recommended to make this directory different from other two main branches preferably in a different partition, device or central database to reduced the risk of unrecoverable lost of user's personal keys due to corruption, system failure, etc. This directory can also server as a media to duplicate and/or synchronize multiple copies of a user's account inside a crypto-gateway server on different machines while the user in a mobile mode (whatever it means).

Each individual private account (“Account 1”, “Account 2”, . . . ) repeats the structure within the dashed box on the left of FIG. 7. The directory represented by long-dashed box on the right of the same figure are default ones which can be reset to other file directories of local or remote file/storage system.

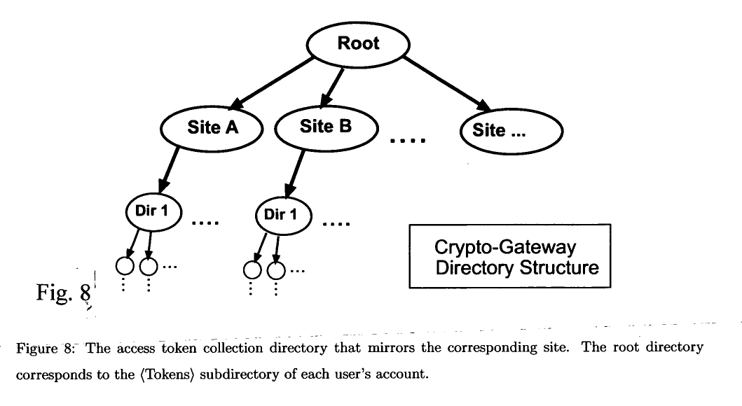

The (Tokens) subdirectory contains access tokens of both local and remote crypto image of contents. Local content is organized by the user of a particular account. There is a default setting for remote contents since their positions are essentially fixed after publication. The access tokens for remote contents are stored according to the same hierarchy as the ones provided by its access URI (without the protocol header) under the tokens subdirectory. What it does is to build a mirror image of the virtual directory structure for crypto-formatted content of a remote site, say “A”, under the (Tokens) subdirectory on the user's private account, as shown in the FIG. 8 where “Dir 1” represents any subdirectory under the root virtual directory (namely, “/”) of the site. There is an one to one correspondence between the access token, which is stored under certain subdirectory of a site, and the corresponding crypto-formatted content data on the remote site. The conventional contents on a websites are not mapped to any of the subdirectories under (Tokens) on the crypto-gateway server.

c) Content Publication Process

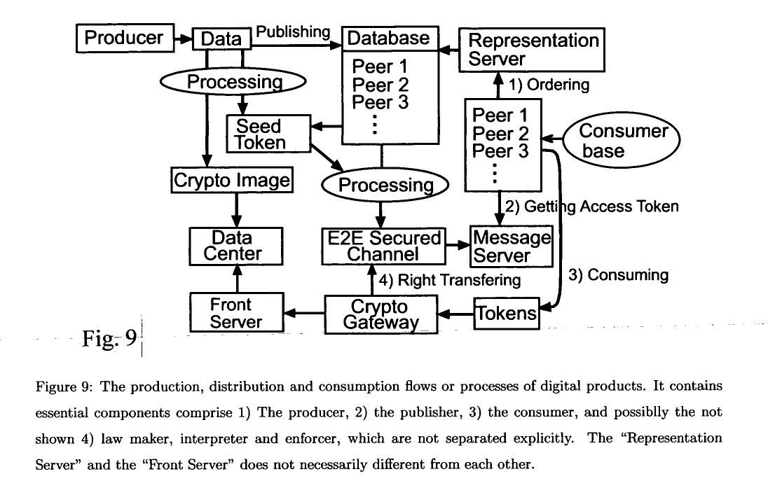

FIG. 9 shows the production and consumption circle of digital content. The content production/consumption flow connects of the following basic elements in a plurality of ways starting from

1. Content production.

2. Crypto-processing, which generates the crypto-image of the data in one of the formats described above and a seed access token with receiver and many attributes unspecified (it is not yet a public access token), it contains the essential elements, namely the random session key encrypted by the sender's private key.

3. Distribute the crypto-image of the content in a plurality of ways, including websites, peer to peer network, network cache, CD or DVD, etc.

4. Publication. Let potential users of the content know the existence and quality or usefulness of the content. The first objective can be achieved in known ways. The second one can be achieved by distributing public tokens, presumably time limited, for potential users to preview the content without any conditions.

5. Establish an online service to accept potential orders.

6. If valid order comes, then do the following.

7. For each valid order, generate a collection of access tokens for the content from the corresponding collection of seed access tokens, which contain all the needed information for the final usable ones. Pack them in one file using a plurality of pre-defined packing format, which is secured and sent via, e.g. e-mail or other messaging channels to the user who did the ordering. The delivery of the secured access token collection file can also be made automatic in real time if the order validation can also be done in real-time.

8. After the secured token collection message is received by each one of the users that placed a valid order, the system first authenticate they are indeed the intended receivers and then install the token collections automatically into their crypto-gateway server account.

9. A user who has a proper access token can access the crypto-image of the content either remotely or locally (local cached copies can be used to increase efficiency and availability) with the help of the crypto-gateway server in real time.

10. A user can also lease or transfer his/her access right to the content (realized by the access token collection) to his/her peers by using the corresponding functions of the crypto-gateway server.

The contents on the internet are composed of a collection of items that are inter-linked to each other. Crypto-processed items described above that are stored on the internet have links to one another in terms of secured link, called crypto-hyperlink. It is different from a conventional hyperlink (to plain contents). A crypto-hyperlink contains information about how to retrieve an access token from a crypto-gateway server that is set up to access the corresponding crypto-processed item. It embodies, in some sense, an additional level of controlled indirection compared to hyperlinks on the internet.

FIG. 5 shows the process of a controlled indirect data retrieval through a crypto-gateway server (solid line) and the conventional data retrieval processes (dashed-dotted lines). The dashed and solid lines represent the dialog between the client, the crypto-gateway server and the “data server”, in which the identity of the user of the client software is authenticated and the source data identity is checked against the record stored in the access token. If everything is ok, the data is retrieved and processed by the crypto-gateway server on its way to the client software.

In principle, such a multi-level controlled indirection (for the contents on the internet) can be extended to more than just one, namely, the content of a web item itself can be an access token and the web server holding it is another crypto-gateway server.

Two kinds of “frequency” concerning the crypto keys used to process the content collection affect both the performance and the security:

1. How frequent a particular user's public key changes across all items that the user is interested in.

2. How frequent the key for the block cipher changes across all items that the user is interested in.

The higher these two frequencies, the better the security and the worst the performance. The opposite is also true. If the user navigate within a set of content items produced using only one user's public key, the user is authenticated only when he/she visit the first item in the set of items. However, each time a user's private key (corresponding to the public one supplied in placing the order) is changed when the user navigate from one web item to another, an authentication dialog (page) will be presented to the user before the new item can be recovered. The user has to supply the correct user name and pass phrase pair (or other forms of personal characteristics) for the new private key in order to have the crypto-gateway server process the item. This makes the navigation less comfortable, but the constant authentication of the user make it less likely for a compromise of security.

The key for the block cipher used in the encryption affects the performance and security in essentially the same but less significant way, namely each time the block cipher key is changed when the user navigate from one web item to a next one, the key will be recomputed, which makes the response slower. However, the more frequent the block cipher key is changed, the less chance that any individual key will be leaked to an attacker. It make it even more difficult for this attacker to completely break the site since he/she has to know every individual keys in order to do so. However, switch block cipher key do not have any apparent effect on the user interface; the computation is done automatically.

Therefore, if the values of the items are not high and performance is an issue, let the user supply only one public key and generate only one block cipher key to process the whole set of content items chosen to be included in the right protected portion of a web site. Otherwise, the producer has the option to divide the selected collection of items in different groups, and process them separately. Pack the items in each group in different packages and let the user order each package using different public keys. The items in these groups can be further divided into subgroups, each subgroup is processed using a different key for the block cipher. The extreme case is that each item in the collection is processed separately.

While letting the user to use different private keys to order different parts of your contents is out of the control of a producer, the way how block cipher keys are distributed amount the right-protected content is entirely the responsibility of the producer. The content collection is processed in batch sessions. A batch processing session is composed of the following sequence of actions:

1. Pick the private key as a producer.

2. Select the collection of files to be processed.

3. Process them in a batch with the same block cipher key.

A random security session key is generated or inherited in the first batch processing session and should be kept unchanged in the following batch processing sessions until the producer actively clean it. If the block cipher key is cleaned, a new random block cipher key is generated or inherited (see the following) and will be used in subsequent batch processing sessions until it is cleaned again.

Security session key inheritance is needed in some scenarios. A typical example is that suppose a producer have divided the web content into N set of items, each set is distinct to other ones in that the members of it are produced using a different security session key from the other sets. Now if the producer have finished the set number N and wish to add more files to a different set, say set number 1, then he/she have to inherit a security key from the set number 1 instead of generate a new one. To inherit a security session key from set number i, the producer needs only to pick an arbitrary seed authentication token belonging to that set (number i). The software is made to extract the security session key from that seed token.

The collection of authentication tokens are grouped into product packages that can be securely distributed to the users.

The possibility to preview the content of a portion of a website, like an e-book, is important to a potential client before he/she can make a decision on whether or not to order the collection of access tokens for that portion of the website, even for non-commercial contents without any charge. Such a step should be able to be accomplished easily without involving the formal ordering process. It is also important that such a right is not be extended indefinitely so that the author's right can be protected.

The previewing is realized by the use of public access tokens with a finite expiration time (from the time they are installed on a particular computer) is set. Public tokens can be packed and published along the content for a potential user to download and install on his/her account.

Therefore the producer needs to produce two sets of tokens from the corresponding seed tokens if previewing is enabled for a particular portion of a website:

1. A set of public tokens which are packed and uploaded to the website for downloading. This set of authentication tokens can be produced at any time after the initial set of seed tokens are produced. It can be done in this way because the expiration time for a public token is relative to the installation time. Depending on the content, set a reasonable (relative) expiration time, e.g. one day after installation.

2. A set of private tokens for each particular user. This set is generated when processing the user's orders which is sent out right-away to the user online or via available messaging or peer to peer communication systems. The expiration date for a private token is absolute, namely, it is relative to the production time not the installation time.

With the set of public access tokens installed, a user can read the content of a website before the expiration time of the public access tokens.

One of the characteristic of web publication is that the contents can be updated with little to almost zero cost to the producer. Certain kind of web-contents that contain time-dependent information requires to be updated frequently, such as the price of a stock, the monthly summary a user's bank account, etc. There is another important application that need updating capabilities, namely, a provider may provide generic content spaces or content templates which serve as content containers instead of actual contents. The actual contents for these type of containers are produced by the user instead of the provider, the former can use the space to hold any information that fits the templates he/she wants.

The content update is managed by differentiating source identification number (source ID) and the version number for the crypto-image of a particular content item (see above). An access token can access all crypto-images having the same source ID and different version number. But if the source ID is changed, the access token must also be changed. Therefore the producer has the choice of whether to ask the users to acquire a new set of access tokens for a major update or to use the old ones for a minor updates. In the later case, the producer has the option of maintaining a list of old versions of the contents so that the user can access any one of them without update their tokens. The rekey mechanism described above minimizes the possibility of dictionary attacks based on these multiple copies of cipher files containing minor differences at the “plain text” level.

d) Executables Publication

Software programs are also digital data that the producer can choose to protect and distribute to their users using methods described above, not only because both its and the users' rights can be managed, but also that the integrity of the software can be guaranteed. Making an intelligent modification of a software crypto-image so that it can perform certain extra tasks when the crypto-image is recovered is theoretically as hard as breaking the commonly accepted modern ciphers. It is really hard if possible at all.

Programs or program modules, components are usually run/called by another ones in modern operating systems and applications. Along the chain of relationships, the producer of the programs can also be different. Most of the commonly used ones that an operating system provide is either already protected or has no needs to be protected. A particular producer contributes at certain positions along the chain, the starting position is call the root program in the following. In order to model such a relationship chain, a root program is assigned one or more “input data” which stands for either the real initialization data or a new executable, library, ensemble, etc., on the next level for which the root program provide services or host, surrogate, etc.

The root program can be a newly launched one by the crypto-gateway server or a pre-existing one in the process resource pool. The crypto-image of the program and its “input data” are retrieved through the crypto-gateway server, which is described above. The FIG. 6 is an illustration of the extra steps and functional units involved in launching the executable binary data.

In principle all the components can be distributed on different node computers on a network. The process server is responsible to launch the (root) program after having the crypto-gateway server to recover the program executable data. The crypto-gateway server serves the launched process's needs of recovering the “secret input data”. The process server can be located on the same computer as the client or the same computer as the crypto-gateway server or on a third computer. The design architecture make it possible to setup and implement these different modes of operation in essentially the same way. If the process server and the client is not on the same computer, there could be an additional secured gateway server or tunnel in between them to handle communications between them, if needed.

A program usually takes other data as input and could also output data. An initialization data used to customize the behaviors and features of the root program can be access controlled by the crypto-gateway server to protect certain features of the software.

Such an access controlled initialization data contains the “secret recipe” designed for certain special behaviors of the program. When an access control program is launched by the crypto-gateway server or is allocated from a resource pool, the user is authenticated for using the initialization data and/or the program. This is a quite flexible scheme for producers to control how their products is used base on different terms agreed by them and the users. For example, the root program can be certain programmable meta-program, and the initialization data can themselves be a set of lower level (meta-)programs or modules.

The simplest way for a producer to have the ability to customize their programs is to add many branching points located at various important/busy sections of a program, which branch the program should proceed next at a given branch point is controlled by a “secret recipe”, namely the initialization data. A program controlled in this “distributed way” can has various concrete instances at run time with different behaviors dictated in the secret initialization data. For a person not knowing any of the initialization data, it is like a maze with multiple exits and dead ends. The right paths from the entrance to one of the exits detailed in the initialization file are only a very small fraction of all possible ones. This kind of program is expected to has much less chance of being hacked (at binary level) compared to mechanisms based on single to few point success (for a hacker) tests using binary choices, let alone to be “hacked to a desired behavior” if it has multiple “recipes”.

Another extreme end to this simple one is the use of a virtual machine (general purpose ones like Java VM or C# run time environment, which may not need to be protected since they have no concrete useful feature to an end user), or specialized one designed for a particular problem domain, like a programmable graphic package) and the initial data contain “bytecodes”, intermediate languages or “scripts” running on top of such virtual machines. Here the possibility is limited only by the expressiveness of the language used to program the virtual machine and that of the imaginations of the programmers. These invention could be used to add additional security/protection to the DCOM, CORBA or Microsoft.Net remoting infrastructure across or within local networks.

In another important setting, the initialization data can be used to store block cipher keys and/or private key for the software which are used in situations where the identity of program need to be assured and/or other cryptographic processing is required. The possibility that the software's secret keys are found by an attacker is far smaller than if they are hide somewhere in the program's plain binary executable file.

e) Online Collaboration

Collaboration can be managed by using a central content database. Group collaboration can be viewed as an extension of the publication described above. It is different from publication because authorized users can make changes to the content. This demand can be satisfied within the system. Such a collaboration can be done on the public internet since the access to the content can be controlled by the project members according to its nature. Besides a central server, which can be a web-server with required functionality to accommodate such activities, the following steps are needed

1. The initiators generate the first version of their share of the portions of the content.

2. Distribute corresponding access tokens of their share to corresponding group members. A lock on the content can be realized by issuing only one access token for each portion of the content with WRITE and READ permissions and multiple access tokens for the same portion with READ only permission. These access tokens can be pass around from one member to another by transfer operation described above using the messaging mechanism available to them. Such mechanism comprise e-mail, website message exchange service, private peer to peer exchange, etc.

3. If so desired, using the random sectioned format, each member can mark and sign their own portion of contributions.

f) Server Side Entity Authentication

A “culture context” gatekeeper (see Ref. [2]) that authenticate user's identity. From the security point of view, “culture contexts” are additional layers used to protect a large site from been broken at a single point despite the fact that they are used also for other purposes[2]. The mechanism to realize it is almost identical to the one using in securing web-services described below.

g) Web-Services

The possibility to use the means provided by this invention to secure web-services is mentioned above. The more detailed steps using SOAP headers are given in the following

1. Suppose that a web-service has one protected access point. In such a case, the provider creates an access point file that contain detailed information about the access point and crypto-process them using separated packing mode as described above.

2. Distribute these access tokens to the users of the service. The following requirements by the providers and the corresponding setting that can satisfy them are possible

(a) The provider do not care who is accessing the web-services as long as he/she/it is in the allowed group of some kind. The producer should generate only a single above mentioned access point file. And distribute access tokens to this file to all the allowed users.

(b) The provider would like to divide all the users of the service into smaller groups so that he/she can has a finer knowledge of who is using the service. Typically these different groups also have different priorities to access different features or levels of the service. The producer should generate a different access point file for each group and distribute the corresponding access token to the users in respective groups. The name of each of the access point files must be unique and contains information that can be used as an index to locate the allowed groups in an auditing database.

(c) The provider intends to know exactly who is calling the service. There are at least two solutions to satisfy this requirement

i. Generate an unique access point file for each user and distribute the corresponding access token to the corresponding user. The name of each of the access point files must be unique and contains information that can be used as an index to locate the allowed users in a database.

ii. Have the users access the crypto-gateway server's external web server component (see above) using POST method. The body of the post should contain an access token issued by the user's crypto-gateway server. In the process of establishing the corresponding secured session, the crypto-gateway server can retrieve the sender's (the service user) identity.

3. Do the following for each first incoming call.

(a) The client side crypto-gateway server establishes a security session loaded with the corresponding session key from the access token.

(b) Notify the web-service client software of a key for a chosen hash function (HMAC) that is derived from the session key. The process of transmitting the derived key is not considered a weak security point since

i. The algorithm used to derive the hash function key is irreversible (e.g., an unkeyed hash operation) so that it can not be used to infer the session key even if it is intercepted within the local area network.

ii. The crypto-gateway server and the client software are located within the same local area network.

(c) The web-service server side should also establish a security session and extract the corresponding session key from the seed token of the access point file's crypto-image (or incoming access token).

(d) Notify the web-service server of a key for the same hash function that is derived from the session key using the same algorithm as the client side. Send this key to the web-service server using communication channels available. For the same reason as given above, the possibility for security compromise related to the transmission of the derived key is as small as breaking the reverse the one way function. If the local network is secured, the possibility is further reduced. Assign a credential for clients if every thing is ok.

4. A few comments:

(a) The algorithm used on both side to derive the key for the hash function is identical and is such that it is not possible to recover the session key used to derive it. For an enhancement of security, the algorithm can also be seeded by a sequence number that starts at a random initial value.

(b) These steps are also used to protect the web-service from deny of service or distributed deny of service since the first receiver of the request before authentication is not the web-service server but a simplified web-server. In addition, it is able to find who or which group of users is making the call even they come from different IP addresses.

5. Prepare a challenge response component for the user to authenticate the service before or during the service (see above) using the established security session. After the initial contact of the web-service (crypto-gateway server) by the user, the crypto-gateway servers of both the user and web-service side have established the same session key in the corresponding security session. If the user want to know whether the web-service's side has indeed the same session key as his/hers/its, a challenge containing random message can be encrypted and send to the web-service side to have it decrypt and return it back for the user to compare. If the results are the same, then the web-service side must be genuine.

6. Each of the methods provided by the web-service that requires strong user and service authentication should be accessed in two steps by the user to realize just in time authentication. It eliminates the possibility of man in the middle and/or replay attacks.

(a) A challenge call to crypto-gateway server on the web-service side, in which the client software send an encrypted random challenge to the crypto-gateway server on the web-service side to have it decrypt and send the result back. Both side of the crypto-gateway server should notify their clients (web-service clients and web-service server) of the random plain challenge message. This message serves as the content for the chosen keyed hash function in the step 3b above to generate an access passphrase used in the following. The client software compares the response with the original one after receiving it. If they are identical, then

(b) Make the call to the desired web method. Such a method contain a passphrase field in which the web-service client fills the keyed hash value of the above challenge message using the key derived from the session key. The hashing can be done without the crypto-gateway server since it is simple enough. The passphrase field should be included in the SOAP header instead of the SOAP body of the request.

(c) After receiving the call, the web method check if the passphrase in the SOAP header matches the one it obtains by doing the same hash operation on the decrypted challenge message from the client. If yes, then continue, else then stop and return certain message if needed.

(d) If confidentiality is also required, then encrypt input and output values of the call through the crypto-gateway servers.

7. For other methods that require less security protection, the first two way hand shakes (steps 1-4) should establish a trusted (and authenticated at the time) connection base on traditional credential assigning mechanism when further services are to be carried out without the assistance of the crypto-gateway servers on both sides. It is possible because this invention is consistently build on top of these models. To increase security, the client software running in this mode can implement manual server authentication, which enables a user of the client software to authenticate the server at times of his/her choice by sending random challenge messages and observe the responses that is explained above, or automatic server authentication, which send the random challenge messages to server at random times and observe the responses. The client software warns the user if any mismatch is found.

Of course a particular web-service client software do not have to perform all the tasks above. Possible simplifications comprise

1. Delegate the tasks to a common parent class from which particular web-service client class can be inherited. Some extra but simple programming is needed.

2. The tasks can be delegated to a client proxy software. Extra steps maybe needed to set up the proxy.

3. The tasks can be delegated to the web-service framework itself. The client can use the extra security features in a transparent way.

h) Private Peer To Peer Communication and Remoting

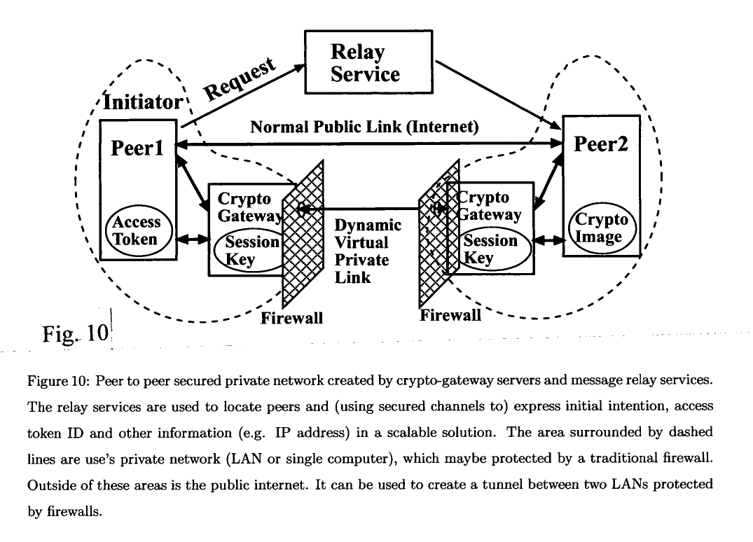

The most secured form of peer to peer communication is realized by using the packed packing mode for messages, because the session key in each message is randomly generated, unrelated to each other, and only one receiver can read the message. However the messages have to be send in blocks which may not be a welcome feature in situations where real-time stream like interactive sending and receiving data in small chunks is favored or the efficiency in data exchange is required in processes that involve large amount of message exchange in short time intervals, like the case in efficient low level support of secured remote procedure call (RPC) or remoting infrastructure that enables trusted LANs to connected together via public internet dynamically (see FIG. 10). Streaming type of secured channel is also required in applications in which the data exchange and the receiving end's reaction to it is in real-time. For example, the real-time exchange of audio or video data.

The first problem that a dynamic private peer to peer communication channel can be established is how the direct connection is going to be established when the initiator is not sure of where or if the intended acceptor is online somewhere on the internet. The second problem is how to notify the acceptor of the intent whence the intention is transmitted in some way.

In order to enable secured peer to peer communication, both peer must have a crypto-gateway server running inside of their own secured/trusted environment as shown in FIG. 10. The steps to establish a security session on both crypto-gateway servers comprise

1. The initiator produce an access point file with relevant information about the conversation context, comprising 1) the IP and port number of the peer to peer communication client software 2) the subject or possible topics of the communication 3) the physical or virtual path to the crypto-image of the context file to be produced, etc. He/She then encrypt the access point file by setting the intended acceptor as the receiving peer and move the resulting crypto-image file to the path specified above. The resulting access token becomes a virtual secured link between the initiator and the acceptor.

2. The initiator prepare an invitation message comprising the following distinguishable components marshaled in a plurality of pre-established formats, like XML

(a) The compressed and base64 encoded access token just established.

(b) The communication parameters for this connection comprise the IP address and port number of the external web server component of his/her crypto-gateway server from which the crypto-image of the conversation context file produced in step 1 above can be retrieved.

In other embodiment, step 2a may be omitted.

3. The initiator send the invitation message, which is also entity to entity secured, using the best known messaging channels between him/her and the acceptor. A few scenarios are possible:

(a) In the first one, the acceptor do not know about the intention and have no means of automatically check he/her message box. Then a notification message can be sent to the acceptor about the intention. The location of the sending agent comprises

i. Inside the initiator's network environment. The means comprise 1) telephone 2) wireless phone 3) internet instant message and its wireless network extensions, etc.

ii. On one of the servers in the message relay (chain) that provide urgent notification service.

(b) In another one, the acceptor knows about the communication. The initiator send the above mentioned notification. The acceptor can either check (poll) his/her message box regularly.

(c) In a third one, the acceptor has means to know the arrival of new messages. For example there is a service can be used which is able push the message to his/her computer and he/she will be notified. In this case, just continue wait.

4. After receiving the secured message, the acceptor recover the message. If he/she agree to accept the invitation then do the following. If not, notify or ignore the calling peer.

5. The acceptor tries to access the secured context file using the url provided in the invitation message during which a security session is established in his/her crypto-gateway server.

6. The external web-server (for the crypto-gateway server) on the initiator side senses the access of the particular context file and establish a corresponding security session on the crypto-gateway server too.

7. The acceptor send a first “hello” message using the secured channel just established to initiate a handshake process. The most likely case is that the first “hello” will resulting in a response since it is expected that the security session on the initiator side will be established before the acceptor's because the “hello” message is delayed by a two way network traffic plus the time for similar session establishment on the acceptor side. In case of failing, the acceptor should be able to try several times.

8. The initiator wait for the completion of the handshake process after establishing the security session and continue the communication if the handshake is successful.

The advantage of the above way of establishing secured peer to peer secured communication channel is that it is essentially a many (peer) to many (peer), service oriented mean. The virtual channel established can last beyond one communication session. The relative complexity is it's disadvantage. A simpler, one (peer) to one (peer) oriented secured communication channel establishment involves the following steps

1. The initiator produce an invitation message with relevant information about the conversation context, comprising 1) the IP and port number of the peer to peer communication client software 2) the subject or possible topics of the communication, etc. He/She then entity to entity secure and send the message through a pre-established messaging system, using means described in this paten, with the acceptor (or responder) as the receiver. The various scenarios about how the acceptor detects the existence of the message discussed above still applies in this realization.

2. During sending the message, the crypto-gateway server on the initiator's side acquires a security session.

3. After receiving the secured message, the acceptor recover the message. If he/she agree to accept the invitation then do the following else stop.

4. The acceptor tries to retrieve secured message from the said message system during which a security session is established in his/her crypto-gateway server.

5. The acceptor send a first “hello” message using the secured channel just established to initiate a handshake process.

6. If the handshake is successful, a private secured communication channel is established between them.

i) Digital Cash

One of the problems facing today's e-commerce is how to protect the customer's financial property and privacy. This invention has the potential to solve both of them. Organization which is capable of insure such activities, like banks in a wider customer circle or commercial organizations in its own customer circle, can issue digital cash based on an out of circulation fixed deposit of real corresponding value (like gold, diamond or paper currency or even credits), by mean(s) comprise generating electronic version of the corresponding cash bills. This digital form of bills are crypto-processed with the crypto-images saved in certain location, which can be in a central location (like the banks database) or having the users who own it download to their local machine. A user can get a portion of the electronic version of their deposit or credit with the bank in the form of access token, issued from the bank or organization(sender), that can access the crypto-image of the representing digital bills. Since the access token can be traded and is not duplicable, these access tokens can be used as a way of securing peer to peer financial transactions without a direct involvement of the bank or organization. The value of a bill is represented in the crypto-image and the right to use that bill is represented by the access token. If the name of the crypto-image of the bill is so chosen that it contains no information about its value, then, personal financial privacy can be secured. It is because only the owner can access the bill. The issuers must guarantee that if some of these bills are transferred back to the them by their clients, they must be able to provide either service or goods, or equivalent values, gold, diamond, etc., and value representations, like paper currency. Of course a practical implementation at present may require the use of certain distributed clusters of registration servers [8] controlled by trustees [10], and therefore the transaction using the digital cash is not entirely anonymous.

In addition, there can be an option to has a third party escrow agent to delay the exchange involving relatively large amount of values until both parties are satisfied to ensure safe exchange of goods and currency, like the one used in credit card transaction. It nevertheless avoids many of the pitfalls [9] of the currently envisioned version of the similar means of digital exchange.

j) Internet Based Voting System

The internet provides an additional mean [13, 14] to organize and administrate voting processes with reduced cost and potentially higher accessibility and reliability. There are various concerns over the possibility of building internet based voting (e-vote) systems using current technology [12]. There are two area of concerns

1. Social one. A voting system should make impossible that

(a) A voter is coerced to vote for a particular candidate.

(b) A voter may vote more than once for his/her favorite candidate.

(c) A voter is willing the sell his/her vote for personal gains.

(d) A politician could use his/her resources to buy votes from the voters.

2. Technical one. The security systems of today is not robust enough to handle well funded breakthroughs that could compromise both the outcome of the vote and the voter's confidence on the voting system.

The first and second concerns in the social category can easily be solved using the anonymous electronic voting system described in the following. The third and fourth concerns in the social category originates from human mind itself. Any technical solution can not solve that. It is therefore harder to tackle since they could occur in the public polling system used today too.

The worst scenario of interest to a security system would be that due to the high stake involved, an interest group/party could do whatever it takes to manipulate the voting results using hacking tools available, comprise

1. Using hacking tools to change the voting results before the software send the voter's actual vote into the secured channel.

2. Launching attacks to the effects similar to a distributed denial of service attack (DDOS) on the central voting server to sabotage the voting process.

The risks can be significantly reduced using the techniques of the declarative authentication and security system of this invention. The action taken to achieve this comprise the following steps

1. The organizer of the process establishes a unique key box (see above) for each potential voters. Using an automatic third party agency to randomly distribute these empty key boxes to the voters considered. The third party agency, which is likely a computer with its records remain unaccessible during processing is used to hide the information about which key box is sent to which voter. Any information that could lead to find such a correspondence is eliminated after the processing by the third party. The distribution process must guarantee that no multiple key boxes is delivered to the same voter and some voter do not receive any voting key boxes. This can also be achieved using our entity to entity secured channels.

2. The organizer of the process announces a list of authorized public key certificates which are used to receive voter's ballots using entity to entity secured channels with the voters as the senders.

3. The organizer of the process generate a ballot form page for voters to cast vote.

4. Each intended voter produces a private and public key pair inside the key box received and makes an anonymous certificate out of the public key (see above). Send the resulting certificate back to the voting organizer to register for the voting. The voter should be instructed to put a common value among all voters, like “A voter”, in the group information field so that tracing individual-voter becomes impossible.

5. Let the voter send the crypto-image of their potential ballot to the organizer, where it is uniquely identified using, say, the GID of the voter's key. The crypto-image of the secured ballot can be sent before the final voting date to one of a cluster of a large number of ballot storage servers distributed amount various voting areas. The point of doing so is to have multi-access voting points to prevent centralized DDOS attacks. The voting software should generate two access tokens for the secured ballot.

(a) To the voting organizer, it is sent to the announced authorized receiver described above using certain distributed messaging system that is hard to sabotage. This access token allows READ only.

(b) To the voter (the receiving certificate do not have to be the anonymous one produced above), which is kept in local storage of the voter. This access token allows both READ and WRITE.

6. Now the voting organizer has a record of vote that may or may not be the actual one the voter casted due to the possibility of been hacked by hacking software. So it should be counted as effective only after the following verification is done.

7. The voter review his/her ballot using his/her own access token. The result should be output in more than one forms, e.g., in visual, possibly audio forms, with the assistance of anti-spyware mechanisms. It make it harder for a hacking/spy software to explore all of them consistently. The software protection techniques of our also reduce the possible maneuvering space for hackers, especially the more traditional hacking tricks. If the ballot is what the voter intended then he/she cast that ballot by marking it as such. There is no need to change the access token of the voting organizer since the marked vote is treated as an update (see above). And the cluster of distributed voting servers automatically send the valid ballots to a hidden central server via certain secured mean to have the vote counted and stored for later auditing. The secured mean can be SSL or the one described in this invention. To prevent the possibility that the process of sending the valid ballots been blocked by a hostile party, each storage server should also have a local count of its own so that later auditing is possible.

8. If the ballot is found to be modified. The voter should also mark it as such. Instead of making corrections to the modified ballot and treat it as an update, the voter has to send a new ballot, starting at step 4 of above.

9. If the voting system detects a large number of fraud ballots or voters trying to make multiple votes, warning can be given to take proper actions.

10. The ballots will be held in storage for certain amount of time for voter to check their ballots again in an independent hardware/software setting provided by the voting organization if serious problem arises (e.g., a smart hacking software is found to consistently modify both input and output of the ballot in both the visual, audio, etc. channels). The existing records can serve as audit trails to trace the source of the problem. Such an ability can also discourage illegal activities since the interest group has to consider the price to pay whence such activities are unearthed.

11. If additional audit information is needed, the initial ballot and the final one can be kept in two different (version of) files.

As it can be seen that the possible attacks on such a system build according to the above procedures backed by the current invention can not be effective. The complexity involved in the process can be simplified by the voting software. From the voter's point of view, the automatic process would involve three simple steps

1. An invitation to vote is received in a secured channel requiring the voter to provide a username and passphrase pair or finger print or biometric information, which is used for later authentication. (In the initial phase of the system, the voter may not have a personal certificate so the delivery of the invitation has to be done in other reliable ways).

2. The voter click the designated link in the invitation message when he/she is ready to vote which brings him/her to a page from some of the storage servers nearby containing an empty ballot. The voter makes his/her choice and submit it back after been authenticated. The actual secured result received by the storage server is immediately feed back.

3. The voter choose ok or not depending on whether the returned result is the same as he/she initially made and submit back again.

All the intermediate steps are standard ones that can be done in the background automatically.

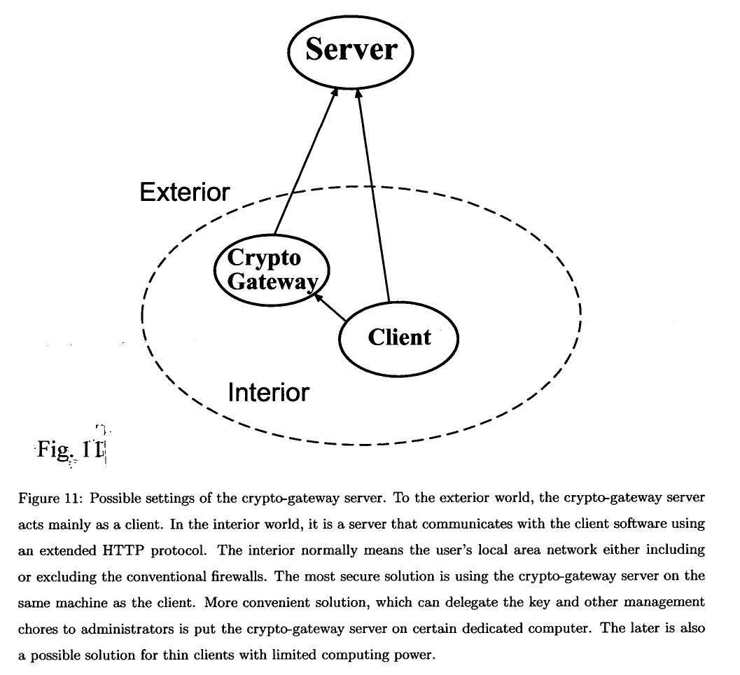

Finally, a choice for the security zone of a crypto-gateway server (see FIG. 11) has to be made according to various application needs.

If security is of prime concern and the client software is running on a computer with sufficient computational power, then it is recommended that the crypto-gateway server should be set to run on the same computer as the one which client software runs. Further measures to increase security beyond the ones that cryptography can provide comprise

1. The use of privately shared key certificates amount a group of peers. This can avoid the possible exposure of one of user's digital IDs (namely the corresponding Key ID or GID,id pair) that is not meant to be published on the internet.

2. The use of anti-spyware features to reduce the possibility of spy softwares on your computer to intercept and/or modify the messages before or after they enter or leave the crypto-engine.

3. Make sure there is no key logging spy software on the computer.

4. Have multiple private keys for different security requirement even the key length is the same and do not mix them in use.

5. etc.

If security is not as important as providing authentication (to the external internet), especially when the client software is running on a less computationally capable computer, and there are specialized personnels in the user's organization who are in charge of managing security issues, then the crypto-gateway server can be set up to running in a local area network environment. Multicast based applications in which the instances of authorized client softwares run in essentially passive ways on different machines to receive content delivery also has to be set up in the local area network setting.

k) The Client Software

The demand on the client software to be able to use the security measures provided by a crypto-gateway server is intended to be as little as possible beyond the abilities they already have when communicating with the external internet without the crypto-gateway server. The new functionalities that a client software provides, beyond the ordinary ones comprise the following types

1. A mini-server component used to receive crypto-gateway server event notifications and response to them.

2. A control component (and the corresponding buttons, forms and something equivalent on the user interface) to control the crypto-gateway server and forward the client credential used by the crypto-gateway server to impersonate the client.

3. A content scan component that is capable of recognize special tags contained in the content used to enable certain security policy and/or exchange information about the crypto-gateway server (IP and port number within the LAN or local host). It also is capable of detecting of and generate warning for inconsistencies in the security taggings.

4. Response to authentication requests from the crypto-gateway server.

5. Manual or automatic server authentication through the crypto-gateway server using means comprise web-services, etc. A status sign and a manual authentication button on the client user interface panel.

6. A user interface display/hide panel to show the status of the crypto-gateway server.

7. A user interface display/hide panel to show user's key status. Independent or join the above one.

8. A user interface display/hide panel to show user's peer's certificates in a hierarchical fashion. Independent or join the above ones.

9. A user interface display/hide panel to show certificate verification status and the corresponding peer certificate information.

l) The Server Side

The demand on the sever software to be able to use the security measures provided by a crypto-gateway server is basically none since a server is regarded as a data retrieving service that knows as little information about the two end points of exchange (information or products) as possible. In that sense a fake server that tries to steal the identity of a genuine one is welcome for the extra service/route provided if it does not slow down or interrupt the communication. The server pages need to be formatted in a particular way in order utilizes some of the more advanced features which requires authenticate server side software, the site itself, etc.

Several pre-conditions exist when a client make use of the crypto-gateway server to handle a request. This is because the server site contains mixture of secured and unsecured public contents, which is schematically shown in FIG. 11. They comprise the following scenarios

1. The previous request is handled through the crypto-gateway server and the response the client would get contains at least one link that need to be handled by a crypto-gateway server.

2. The previous request is handled through the crypto-gateway server and the response the client would get contains no link that needs to be handled by a crypto-gateway server.

3. The previous request is a direct request, without been handled by the crypto-gateway server. In addition, the response that a client would get contains at least one link that needs to be handled by the crypto-gateway server.

4. The previous request is a direct request, without been handled by the crypto-gateway server. In addition, the response that a client would get does not contain any link that needs to be handled by the crypto-gateway server.

### Conclusion, Ramifications, and Scope

The result is a machine independent, simplified, flexible and scalable realization of the design goals listed above.

Detailed logic flows and their variations, the means of utilizing the resulting functionalities and system, etc., are presented. Other realizations within the broader spirit and scope of the ones as set forth in the claims may also be possible and is covered by this patent.

For example, extend an existing protocol to realize certain or all of the functionalities described.

I claim:

1. A global digital entity identification mean comprising a plurality of identification schemes for personal key storage units or key boxes belonging to the said entity used to contain key data for security means comprise a public cryptographic one etc. The said key data comprises the collection of all relevant information pertaining to the key or keys for the said security means. The said key storage units may have names comprising “key boxes” (used in the sequel), “key containers”, “key storages”, etc., stored in any media, which serves as logical key boxes used in the application domains implicitly or explicitly claimed by this patent.

2. The method of claim 1, wherein the collection of digital information used in the said identification scheme to identify a key data constitutes one of the digital IDs for the said entity to whom the key data belong.

3. The method of claim 1, wherein the identification scheme comprise an unique global identification number (GID) for a particular key box and a locally unique identification number for a particular personal key data inside the said key box.

4. The method of claim 3, wherein the said GID and possiblly the local id together constitutes one of the digital IDs for the entity to whom the key data (keys and certificate) belong.

5. The method of claim 1 realized in a public cryptographic security system, wherein there are two copies of a public key encapsulated in different forms for a public cryptographic system.

6. The method of dependent claim 5, wherein the first one is a private copy containing the status information of the key pair comprising 1) a list of remote certificate listing sites where the corresponding key certificate is published 2) the key properties 3) whether or not the certificate on the remote site is uptodate, etc.

7. The method of dependent claim 5, wherein the second one is a public copy, or the key certificate. It contains, among others, the entities registered name and the public key, which is digitally protected against modifying.

8. The certificate of dependent claim 7 containing subjective attributes.

9. The attributes of claim 8, wherein a subjective trust factor in key certificates of human entities is used. The private copy of a peer's certificate in the local storage of a human entity can be adjusted based on his/her degree of trust of the said certificate and/or the entity behind it. The public copy of entity certificates published in a plurality of public accessible means have a neutral trust value.

10. The certificate of claim 7, wherein anonymous certificates are generated with null or common value replacing the personal information.

11. The method of dependent claim 3, wherein the said GID further comprises forms derived from a 16 byte value and a corresponding hash code and the local id comprising forms that can be derived or mapped from a value at least 2 bits in length.

12. The method of dependent claim 11, wherein the said GID is either produced in a form comprise any characteristics and their derivatives about the entity and/or the environment pertaining to the said entity or in a random form.

13. The method of claim 1 realized in a public cryptographic security system, wherein the said private key is secured in a plurality of ways without saving the selected set of the entity's unique characteristics, which are used to access the key boxes and private keys belonging to the said entity.

14. The method of dependent claim 13, wherein two pieces of an entity's unique characteristics are used, which are processed to generate two keys using a plurality of algorithms. The said two keys are used in the following ways.
(a) Using one of the said key, the hash value of the private key is computed using a plurality of keyed hash functions.
(b) The private key is encrypted by one of a plurality of block ciphers using another one of the said keys.
(c) The encrypted private key and its keyed hash value are packed in a plurality of means and saved in the private key box with or without a descriptive header preceded.

15. The method of claim 1, wherein the said key box is access controlled by a plurality of means which utilize a key derived from one of the entity's unique characteristics, i.e., the hash value of a privately memorized passphrase or other digitizable ones. Either the said key or a value derived from it is used to identify a user cryptographic account of the system or an independent said account identification scheme is used.

16. The method of claim 1, wherein each key box has a backup copy stored in a storage media. The said copy is used to prevent key corruption and/or to facilitate account duplication and synchronization between different copies of the same said cryptographic account.

17. The method of claim 1, wherein there is a protected field in the key box for the private key in which a fail counter is used to record the failed attempts of retrieving any one of the private keys inside the key box.

18. A format for secured messages comprises an major header that contains global identification information of claim 1 about the sender, an encrypted minor header and an encrypted content body. The said major header is either encrypted or not encrypted.

19. The method of claim 18 realized in a public key cryptographic security system, wherein the major header contains the digital ID of a “sender” and that of zero to a finite number of “receivers” used to retrieve the corresponding cryptographic keys and the corresponding certificates. It also includes an document serial number of multiple bytes used to validate the content body. It can further include a maximum length field and other relevant information comprising the date of the production, return and expiration, the header version number, header and document access authorization, content format, etc.

20. The method of claim 18, further includes an encrypted random session key and the initialization vector (IV) used to derive a key for a cipher to encrypt the minor header and the content. The encrypted random session key is processed in steps comprising
(a) Encryption by a private key of the “sender”.
(b) Encryption by a sequence of zero to any number of public keys belonging to the corresponding sequence of “receivers”, including the zero one.

21. The method of dependent claim 20, wherein the case of
(a) Zero encrypting “receiver” is used to provide public access means to the content.
(b) One encrypting “receiver” is used to provide private access means to the content.
(c) More than one encrypting “receivers” is used to provide content escrow means by the group of receivers.

22. The process of providing content template or container services based on dependent claim 19, wherein the return date is used to manage leased or rented said services. It may include the feature that any version of a content can be accessed if the receiver has already acquired the access right for earlier versions of the same content.

23. The method of claim 18, wherein the minor header contains information comprising padding information about the encrypted content and the document serial number of multiple bytes that is used to match the one in the major header and a multi-byte document version number used to identify different versions of updated content. It is encrypted by the session key contained in the major header.

24. The method of dependent claims 20, wherein the key for the cipher used to encrypt the message body is regenerated using a deterministic algorithm seeded by the session key stored in the major header and the data derived from the minor header.

25. The method of claim 18, wherein the content body is formatted in forms comprising
(a) The content contains selected secured sections. A selected group of the said sections are each first digitally signed by one or more corresponding entities and then encrypted and the rest of the said sections are encrypted but not digitally signed. The signer for each one of the randomly secured sections can either be different or the same.
(b) Block secured sections in which the content is divided into blocks of fixed size (except for the last one). These blocks are first all digitally signed by a single entity and then encrypted or all encrypted without been digitally signed.
(c) Stream secured in which a stream cipher is used to secure the content body.

26. The options of dependent claim 25, wherein the sender can be different from the signer or signers.

27. The method of claim 19, wherein there two packing schemes for the message:
(a) The major header, the minor header and the content body is stored in a common storage location or transmitted across thread or process boundaries in a sequential order.
(b) The major header which is encapsulated into an access token that serves as a secured three ends virtual link is stored separately from the minor header and the content body.

28. A process derived from the method of dependent claim 26, wherein the sender acts as an arbitrator, witness or notary agent for the signing of papers by a group of signers of the said papers, which are prepared in the said random sectioned format.

29. A secured virtual link comprising information about sending, receiving entities and cryptographically processed content, which serves the purpose or realizes the functionality of the major header in claim 18. It is also called access token in the sequel.

30. The method of claim 29, wherein the components of the said virtual link comprise the message major header, the value of a digital signature or hash operation on the said major header and other information, including the URI of the encrypted content.

31. The process based on the method of dependent claim 29, wherein access control scheme is used in providing selected multiple (including one) private access control to a secured content where the security and integrity of the content and the authentication of the sending and receiving entities are assured.

32. The method of dependent claim 31, wherein the escrow mechanism is used to providing additional access channels to guarantee the accessibility of the content.

33. The process based on the method of claim 29, wherein the receiving entity's access right is transfered to itself or to a different entity.

34. The method of dependent claim 33, wherein such a mechanism is used in ownership trading activities comprising copyright protected contents, digital cash or its future equivalents, valuable goods trading, etc.

35. A crypto-gateway “server” approach to centralized entity cryptographic keys and peer certificates management, cryptographic processing, etc., to provide a mean for establishing a scalable declarative digital identification and authentication system in distributed or centralized applications wherein the “server” comprise any hardware or virtual devices, operation systems virtual or not, systems, software collections, etc. that processes requests either in a serialized or concurrent fashion with control means comprise monolithic, micro-kerneled, centralized, distributed, etc. The term “server” is also used to denote any processes, fibres, jobs, threads running within the client software's process or running outside of it or running on a different operating system or on a different hardware platform controlled by the same or different operating system as the one where its clients reside, that serves the purpose of a server. The scope of “centralization” is limited to a trusted local area network, a single computer (virtual or not), a group of related fibres, jobs, processes, application domain, or even threads, etc. The said crypto-gateway server communicates with client softwares using a plurality of protocols.

36. The system of claim 35, further include means of communication with the client software or process using available ones at the time inside an environment that can be considered internal and/or at least partially secure.

37. The system of claim 35, wherein the crypto-gateway server comprises at least one of the following components
(a) An extended server component that understand common protocols. In addition it also understand specialized control protocols for the purposes comprising the control of the behaviors of the crypto-gateway server. This component communicate with its client software in the said internal environment.
(b) A client proxy component to communicate to the external network for the said client software using common protocols. The client software can be a server, client or both to other softwares inside or outside of the said internal environment.
(c) A cryptographic engine serves the purpose of cryptographic processing described above. It contains sub-components comprising any combinations of the following with at least one crypto-graphic channel involved
i. Direct pass channel, in which the content is delivered to or from the client proxy without modification.
ii. Messaging channel, in which the content is cryptographically processed, packed in whole before passed to the client proxy or received by client software.
iii. Streaming channel, in which the content is sent to or received from the client proxy in small chunks during the cryptographic processing.
iv. Components used to interact with local and remote key and peer's certificate storage or databases according to the control commands of the client software.
It can run in the same or different process spaces, the same or different computers (virtual or not), etc., compared to the crypto-gateway server.

38. The dependent claim 37, further include an external server component that understand common protocols that is used to response to requests from external network. The external server component can run in
(a) The same process space as the crypto-gateway server.
(b) An independent process space as the crypto-gateway server.
(c) A different computer or device from the crypto-gateway server.

39. The dependent claim 37, wherein the server component establishes a security session to keep an expirable security state related to the said cryptosystem for each one of the independent instances of a plurality of running client softwares in the said internal environment.

40. The system of claim 35, wherein the media for the distributed application environment comprises the internet, within or across, e.g., intranets, wide area networks or local area networks. The media further include wireless networks that is independent or part of the internet or connected to the internet directly or through gateways.

41. The system of claim 35, wherein crypto-gateway server or/and its components is realized by single or multi-purpose systems comprising
(a) Specialized processors, chips, etc.
(b) Specialized operating systems based on specialized or common hardware, including smart cards.
(c) Any other virtual machine or systems not yet included.

42. The system of dependent claims 37, further include application to copyright protection of digital products, where the digital products comprise
(a) Textual, graphical or visual, audio, etc., media.
(b) Executables comprise programs, program components, dynamic libraries, assemblies, byte-codes, etc. It can further include data files consumed by the said executables, which are also access controlled using the plurality ways of this invention wherein the data files contain content comprising
i. Cryptographic keys of the software.
ii. Scripts, compiled intermediate codes, assemblies, dynamic libraries, etc. for the said executables.
iii. Initialization data.
iv. Any combination of above.
(c) Any combination of above.

43. The method of dependent claim 42, wherein the copyright protection is realized by using access tokens which is protected by a plurality of copy management techniques for the said access token.

44. The method of dependent claim 42, wherein the digital products are content container or templates.

45. The system of dependent claims 37, further include application to group collaboration on the internet, which comprise at least one of any combination of the following steps:
(a) The project initiator publish an initial set of contents in project servers comprising web-server, ftp-server, etc.
(b) The project contents are divided into different portions.
(c) The project members are divided into different groups.
(d) Each portion is cryptographic processed to generate a set of corresponding crypto-images.
(e) For each crypto-image belonging a group, a set of READ only access tokens are issued to each member of the group and some access token with READ & WRITE authorization are generated.
(f) Any WRITE enabled access token has limited numbers, e.g., one.
(g) The WRITE enabled access tokens are passed, transferred among members of the group to serve the purpose of content update synchronization lock.
(h) For any new contents added in during the development, repeat above process.
(i) The member possessing WRITE enabled access tokens has the chance of updating the corresponding portion of the project contents.

46. The system of dependent claim 37, further include application to secure peer to peer data exchange and/or communication across any network connected to the internet, including wireless networks that are independent or part of the internet or connected to the internet directly or through gateways, where entity authentication is required at least for one peer.

47. The method of dependent claim 46, wherein the messaging mean comprise electronic mail system, message queue system, remoting system and their extensions into the wireless network system comprising
(a) A real-time peer to peer network system.
(b) A supporting or application layer for a secured remote function call infrastructure system.
(c) A hybrid of any possible combinations of the said systems and their ramifications. One of the said messaging means is also used as a direct or a relay channel to initiate secured communication.

48. The method of dependent claim 37, further include application to secure web-services using access tokens prepared and distributed by the provider of the said service.

49. The method of dependent claim 48, further include setting up access auditing and filtering subsystems at the access points of the service where three levels of auditing can be performed:
(a) Indiscriminative
(b) Group granularity and
(c) User granularity.

50. The method of dependent claim 48, wherein user and service authentications comprises 1) first time authentication combined with traditional trust based authorization 2) just in time authentication and authorization.

51. The method of dependent claim 48, further includes an external web-server running in a different process or computer from both the crypto-gateway server and the web-service to serve as the first allowed access point of the web-service, where access information logging can be turned on or off. It can also be used to protect the web-service from anonymous denial of service or distributed denial of service attacks by blocking suspicious or abnormal attempts.

52. The system of dependent claim 37, further include application to digital cash used to carry out financial transactions in which the issuer choose to hold a chosen amount of contemporary recognized value or its representation, comprising gold, diamond, paper currency, etc., out of circulation or it/he/she does not choose to do so. The issuer secures digital bills using the separated packing mode for messages (content) of this invention by setting itself as the sender end of the virtual secured link and the digital cash receiver as the receiver end of the same link with the encrypted bill of selected face value as the crypto-image.

53. The method of dependent claim 52, wherein the digital cash is used in an anonymous way or in an semianonymous way in which a group of agents comprise the issuer, its representatives, other authorized agents, etc. assists or monitors the transaction in certain ways.

54. The method of dependent claim 52, further include digital cash escrow activities wherein agents who act as trusted third parties in financial transactions of relatively large quantity. One embodiment is that one of the said agent temporarily hold the digital cash payment for products or services until both sides involved in a transaction, especially the client side, is satisfied or if problems arise, until the problems get settled either between themselves or in the court of law.

55. The system of dependent claim 37, further include a secured peer to peer data exchange and/or communication component, wherein the secured communication channels are used to form a general purpose virtual private network on top of an existing network using a plurality initialization means over the said existing network where the initiator and the acceptor are authenticated and a common block cipher key is set for both peers involved.

56. The method of dependent claim 55, wherein the secured peer to peer communication channels are utilized in a plurality of scenarios comprise
(a) Providing a foundation for secured extension of existing remoting infrastructures.
(b) Supporting new type of remoting infrastructures.
(c) Providing a virtual private channel for delivering a wide variety of real-time data, copyright protected or not.

57. The method of dependent claim 37, further include application to provide a security and management layer for building digital voting system using the technologies of this invention.

58. The system, process of managing, protecting, distributing, transferring and utilizing digital ownership or any other “rights” conceivable embodied in the access tokens of claim 29.
